(19) United States
(12) Patent Application Publication
(10) Pub. No.: US 2021/0216540 A1
(43) Pub. Date: Jul. 15, 2021

(54) ACCESSIBLE AND EFFICIENT SEARCH PROCESS USING CLUSTERING

(71) Applicant: Adobe Inc., San Jose, CA (US)

(72) Inventors: Minal Bansal, Hisar (IN); Prasenjit Mondal, Panchgechia (IN); Sanjeev Tagra, Panipat (IN); Sachin Soni, New Delhi (IN); Ajay Jain, Ghaziabad (IN); Andres Gonzalez, Wake Forest, NC (US)

(73) Assignee: Adobe Inc., San Jose, CA (US)

(21) Appl. No.: 16/739,678

(22) Filed: Jan. 10, 2020

(51) Int. Cl. G06F 16/242; G06F 16/28

(52) U.S. Cl. CPC G06F 16/2423; G06F 16/285

(57) ABSTRACT

Techniques are disclosed for narrowing search requests, based on interaction between a search system and a user. For example, a plurality of search results is generated in response to a search query. To reduce the number of search results, a plurality of attributes or features of the search results are identified. Each feature has a corresponding plurality of clusters, where a cluster of a feature represents a corresponding range or value of the feature. For each feature, the first plurality of search results is categorized into the corresponding plurality of clusters of the corresponding feature. A feature is then selected. The search system interacts with the user, to identify a cluster of the plurality of clusters of the selected feature in which one or more intended search results belong. Based on such identification of the cluster, the search system refines or narrows down the first plurality of search results.

### FIELD OF THE DISCLOSURE

This disclosure relates generally to a search process, and more specifically to techniques for narrowing the search process using focused and selective queries.

### BACKGROUND

When a user wishes to search for a digital asset on a file system (such as a remote or cloud-based file system, or even a local file system stored in the user's device), the user inputs some keywords, in response to which a set of search results are presented to the user. The user can then select a given search result to further explore that result, as desired. However, in some cases, the number of such search results can be relatively high, and the user has to at least glance through individual ones of the many search results to find the desired digital asset. For a large set of search results, this can be a time consuming and frustrating process for a user, especially if the user is visually impaired. In more detail, while a sighted user can leverage the power of glance-based parsing to digest the search results in a relatively quick fashion, a vision-impaired user would need to interact with and interrogate each of the search results one at a time to identify which ones were of interest. Thus, techniques are needed to make the review of search results more efficient. While all users could benefit, such techniques would be particularly helpful for vision-impaired users.

### BRIEF DESCRIPTION OF THE DRAWINGS

FIG. 1 is a block diagram schematically illustrating selected components of an example computing device configured to conduct a search process for digital documents, in accordance with some embodiments of the present disclosure.

FIG. 2 is a block diagram schematically illustrating selected components of an example system comprising the computing device of FIG. 1 communicating with server device(s), where the combination of the device and the server device(s) are configured to conduct a search process for digital documents, in accordance with some embodiments of the present disclosure.

FIG. 3A is a flowchart illustrating an example method for facilitating a search process, in accordance with some embodiments of the present disclosure.

FIG. 3B is a flowchart illustrating an example method for selecting a feature, in accordance with some embodiments of the present disclosure.

FIG. 4A illustrates an example interaction between a user and a search assistant implemented by the search system of FIGS. 1 and 2, in accordance with some embodiments of the present disclosure.

FIG. 4B symbolically illustrates digital assets identified by a result generation module of the search system in response to an initial search query, in accordance with some embodiments of the present disclosure.

FIG. 4C symbolically illustrates search results that are refined, based on categorization of the intended digital asset as being one of textual or non-textual, in accordance with some embodiments of the present disclosure.

FIGS. 4D1, 4D2, 4D3, 4D4, 4D5, 4D6, 4D7, 4D8, and 4D9 respectively illustrate example Mean Deviations (MD) calculations for various clusters corresponding to features f1, f2, f3, f4, f5, f6, f7, f8, and f9, respectively, in accordance with some embodiments of the present disclosure.

FIG. 4E illustrates example features f1, f9 being ordered in an ascending order, based on corresponding Summation of Mean Deviations (SMDs), in accordance with some embodiments of the present disclosure.

FIG. 4F illustrates a table depicting absolute difference between the means of two identified features, and absolute difference between SMDs of two identified features, which are used to generate an adjustment of deviation, in accordance with some embodiments of the present disclosure.

FIGS. 5A1, 5A2, 5A3, 5A4, 5A5, 5A6, 5A7, and 5A8 respectively illustrate example MD and SMD calculations for various clusters corresponding to features f1, f3, f4, f5, f6, f7, f8, and f9, respectively, during a second iteration of the method of FIG. 3A, in accordance with some embodiments of the present disclosure.

FIG. 5B illustrates example features f1, f3, f4, f5, f6, f7, f8, and f9 being ordered in an ascending order based on the corresponding SMDs during a second iteration of the method of FIG. 3A, in accordance with some embodiments of the present disclosure.

FIG. 5C illustrates the absolute difference between the means of the features f1 and f7, and the absolute difference between SMDs of the features f1 and f7, which are used to generate an adjustment of deviation factor during the second iteration of the method of FIG. 3A, in accordance with some embodiments of the present disclosure.

### DETAILED DESCRIPTION

Techniques are disclosed for narrowing search requests (e.g., reducing a number of the search results), based on interactions between a search system and a user. Although the techniques can benefit any type of user, they can be particularly helpful for vision impaired users. In some embodiments, a plurality of initial search results is generated by the search system, in response to an initial search query from the user. These initial search results can then be further refined in one or more stages. For instance, according to one such example embodiment, a first refinement of the initial search results can be accomplished based on a target file type (e.g., if the target file type is a textual file, then non-textual files can be eliminated from the search results, or vice-versa), thereby providing a refined set of search results. A second refinement can then be executed on the refined set of search results, to generate a further refined set of search results. In some such embodiments, this second refinement is accomplished using a clustering-based technique to identify a target feature within the target file. Other refinements can also be used, as will be discussed in turn, and the order of refinements may vary as well. So, one or more refinements can be executed on the search results to cull out results that are likely not the specific asset for which the user is searching. In some cases, at least some of the refinements can be made without querying the user, or with an otherwise relatively low number of user queries. A plurality of attributes or features of the search results are identified. The identified features for a given digital asset can be, merely as examples, whether the digital asset is textual or non-textual in nature, last access time of the digital asset, duration of the digital asset (which is helpful if the asset is a video), genre of the digital asset, and/or one or more other appropriate features or attributes of the digital asset, as will be appreciated in light of this disclosure. The clustering-based refinement can be carried out in a number of ways. In one example case, for each feature, a corresponding plurality of clusters is identified. A cluster of a feature represents a corresponding range or value of the feature. For example, for the feature “last access time,” a first cluster can be less than one month, and a second cluster can be more than one month. The plurality of search results is then categorized into the corresponding plurality of clusters of the corresponding feature. In more detail, and according to one such embodiment, for a given feature, a search result is categorized into exactly one cluster of a plurality of clusters of the given feature. Furthermore, a search result is categorized in (i) a corresponding cluster of a first feature, (ii) another corresponding cluster of a second feature, (iii) yet another corresponding cluster of a third feature, and so on. Subsequently, a feature from the plurality of features is selected, based on how uniformly the search results are distributed among the various clusters of various features. Once a feature has been selected, the search system interacts with the user, to identify a cluster of the selected feature in which the intended digital asset belongs. Based on the identified cluster, the search system reduces the number of given search results. The search system can perform this process iteratively, until the search results are sufficiently reduced (e.g., below a given threshold), according to an embodiment. In some such embodiments, the intelligent and dynamic selection of the feature increases a likelihood or probability of a maximum or otherwise sufficient reduction in the search results during each iteration, thereby reducing a number of interactions required between the user and the search system to reach a sufficiently smaller number of search results. Many variations and embodiments will be apparent in light of this disclosure.

### General Overview

During a typical search process, a user uses one or more search terms to find a stored digital asset. As previously explained, the number of “hits” or search results provided in response to the search query can be relatively high. In any case, the user has to at least glance through individual ones of the search results to find the intended digital asset. This can be time consuming and frustrating for a user, especially for a technologically challenged user or a vision impaired user. Thus, a search system that makes a search process easier or otherwise more accessible would be beneficial, especially for visually challenged people.

Thus, and as discussed in various embodiments and examples of this disclosure, a search system configured to efficiently interact with the user is provided. In an embodiment, the search system is configured to iteratively narrow down or refine the search results (e.g., reduce a number of the search results) presented to the user, based on a relatively brief number of interactions with the user. If the refined number of search results are sufficiently small, a user can interrogate such results to quickly locate the asset of interest. Various example embodiments and use-cases are provided herein.

The search system can be stored on a local computing device of the user, and/or can be located remotely in a server accessible via a network. In some embodiments, the search system aims to search and locate one or more assets that are stored in a file system within the user's local device and/or a cloud-based remotely located file system. However, the principles of this disclosure can be extended to locate files in a bigger database or distributed data systems, such as those accessible via the Internet.

In some embodiments, once the search system receives a search query, the search system generates a plurality of initial search results. Depending on the search parameters and data source being accessed, the number of initial search results may be quite large. A query module of the search system queries the user to determine if the intended digital asset (or assets, as the case may be) is textual or non-textual in nature. Textual digital assets can include, for instance, word processing files (e.g., .doc and .txt files), Portable Document Format or PDF files, spread sheet files (e.g., .xls files), and/or any other appropriate files primarily used for storing textual data (although note such files may also include non-textual content such as embedded videos or audio). Non-textual digital assets can include, for instance, videos, images, graphic files, audio files, etc. In any case, the user can respond to the system's query to identify the category of the intended assets, such as textual, non-textual, graphical, video, image, audio, etc. The search system can then refine the initial search results, to restrict those results within the identified category, thereby reducing the number of search results or otherwise provide a refined set of search results. While this initial refinement may reduce the number of search results, in some examples, such a reduction may not be sufficient. So, in such cases, the search process includes further refinement of the search results.

In more detail, and according to some such embodiments, to further reduce the number of search results, various attributes or features of the search results are identified (e.g., by a feature set and cluster identification module of the search system). Examples of the features include, but is not limited to, (i) the last time the file was accessed, (ii) the length of the video, (iii) the genre of the video, (iv) whether the searched keyword is present in the name of file, (v) a prominent speaker in the video, (vi) the presence of a celebrity in the video or image, (vii) a prominent object in the video or image (e.g, mountain or car), (viii) the presence of music in the video or audio file, and/or (ix) the presence of narration or dialogues in the video or audio file. Various examples presented in this disclosure are based on these nine features, labelled as f1, f2, . . . , P9, although other features and numerous variations will be appreciated.

Then, a feature set and cluster identification module of the search system identifies, for each feature, a corresponding plurality of clusters. As previously explained, a cluster of a feature represents a corresponding range or value of the feature. Merely as an example, for a feature f1 (which can be “File last accessed time”), the corresponding clusters are (C11) Less than a month, and (C12) more than a month. In another example, for a feature f2 (which can be “Length of the video”), the corresponding clusters are (i) less than 5 minutes, (ii) 5-60 minutes, (iii) more than 1 hour. Example clusters of various other features are also depicted in Table 1 and will be discussed in turn. Then, for each feature, the search results are categorized into the corresponding plurality of clusters. Merely as an example a first search result can be categorized in (i) a cluster of “less than a month” for the feature “file last accessed time,” (ii) a cluster of “5-60 minutes” for the feature “length of video,” (iii) a cluster of “comedy” for the feature “genre of video,” (iv) a cluster of “No” for the feature “whether searched keyword is present in the name of file,” and so on. Thus, the first search result in categorized in (i) a cluster of a first feature, (ii) another corresponding cluster of a second feature, (iii) yet another cluster of a third feature, (iv) yet another cluster of a fourth feature, and so on. Note that, in some example cases, for a given feature, a search result can be categorized into exactly one cluster of a plurality of clusters of the given feature. For example, for a feature f1 (which can be “File last accessed time”), the corresponding clusters are (C11) Less than a month, and (C12) more than a month. The first search results cannot be categorized in both the clusters, and can be categorized in exactly one cluster of the feature f1. Further note that, in some embodiments, the clusters are generated and the search results categorized dynamically and on the fly. For example, if the user initially searches for “nature,” the feature f7 (Prominent object in the video or image) can have, for instance, clusters (C71) Mountain, (C72) River, (C73) Forest, and (C74) Other. However, when the initial search query is changed, the clusters for this feature may also change correspondingly. For example, if the initial search query is about animals, the clusters corresponding to feature f7 can be cats, dogs, elephants, bears, and so on, where the clusters are identified based on the search results.

As discussed, in an example, assume there are nine features f1, f9 as discussed above, where feature f1 has X1 number of clusters, feature f2 has X2 number of clusters, . . . , and feature f9 has X9 number of clusters. Also, assume that the number of search results to be reduced is N, where each of X1, . . . , X9, and N are positive integers and greater than one. In some such embodiments, a mean of individual features is calculated, where the mean of a feature is a ratio of total number of assets and the total number of clusters of the feature. Thus, for feature f1, the mean M1 is N/X1; for feature f2, the mean M2 is N/X2, and so on. In some such embodiments, Mean Deviations (MD) for various clusters are then calculated. For example, the MD of a cluster of a feature is an indication of how much a given cluster size deviates from the mean of the corresponding feature. For example, if P11 number of assets are categorized into a cluster C11 of the feature f1, then the MD of the cluster C11 is |P11-M1|. Thus, the MD of a cluster of a feature is an absolute difference between (i) a size of the cluster (where the size of the cluster is a number of assets categorized in the cluster) and (ii) a mean of the associated feature. In some such embodiments, once the MDs for various clusters of various features are calculated, a Summation of Mean Deviations (SMD) for each feature is then calculated. For example, for a specific feature, the SMD is a summation of the MDs for various clusters of the feature. For example, for feature fi (where i=1, . . . , 9 for the example of Table 1 discussed herein later), assume the corresponding clusters are {Ci1, Ci2, . . . , Cix}, where the clusters have MDs as {MDi1, MDi2, . . . , MDix}. Then the SMDi for feature fi is (MDi1+MDi2+ . . . +MDix).

In some such embodiments, the search system aims to determine Asset Distribution Value (ADV) for each feature. For example, the search system aims to determine, for a given feature, how fairly or evenly or uniformly the assets are distributed in various clusters of the feature. A more even or more uniform distribution of assets among different clusters of a feature tends to have a better ADV. The search system then aims to select a feature with relatively better asset distribution. Doing so increases a probability that the selected feature is likely to be most efficient in reducing the number of search results, when the search results are refined based on a user response to a query about the selected feature. For example, a feature selection module of the search system orders the features based on the corresponding SMDs. At least two features having the lowest SMDs among all the features are identified by the feature selection module. As discussed, the SMD being low for a feature implies that the assets are relatively evenly distributed among the clusters of the feature. Thus, an SMD of a feature is an indication of how evenly the assets are distributed among the clusters of the feature—relatively more even distribution tends to have a relatively lower SMD. In essence, SMDs are a good indication of the above discussed Asset Distribution Values (ADV) for various features. Accordingly, two or more features with lowest SMDs are initially identifies. As will be discussed in further detail, one of the two or more identified features is then selected. Various criteria for selecting the feature are discussed herein later in further detail. Thus, the selected feature has a SMD that is lower than the SMDs of most other features.

In some embodiments, the search system (such as the query module of the search system) causes presentation of a query or prompt to the user, based on the selected feature and the corresponding clusters. Merely as an example, in an example, assume that the feature f2 was selected. The query is, thus, based on the feature f2 and associated clusters. For example, the user may be requested to choose among the clusters of feature f2. Merely as an example, feature f2 is “Length of video,” and the associated clusters are (C21) less than 5 minutes, (C22) 5-60 minutes, (C23) more than 1 hour. Thus, the query can be, as an example: “Do you remember the approximate length of the video? Is it less than 5 minutes, between 5 minutes to 60 minutes, or more than an hour?” In an example, the query module receives a response to the query from the user, where the response includes a selection of a cluster of the various clusters of the selected and queried feature. Merely as an example, the user responds as follows: “I think greater than an hour.” Thus, the user selects the cluster C23 (more than 1 hour). Note that queries may be presented to the user with visual (e.g., text) or aural (e.g., synthesized voice) means; likewise, the user can respond to a given query either written or typed response, with a spoken response, and/or via gestures. Based on the user response, the result generation module of the search system refines the search results. For example, the result generation module identifies and includes in the refined results the digital assets belonging to the cluster selected by the user, and discards digital assets belonging to the other clusters of the selected feature. This reduces the number of search results. If the reduction in the number of search results is not sufficient, the search system can repeat the above discussed process to again interact with the user and further reduce the number of search results. This process can be repeated iteratively, until the search results are sufficiently small (e.g., below a user-defined or otherwise given threshold).

Once the number of refined search results is sufficiently small, the search system displays the small number of search results. Because relatively small number of search results are displayed, a user, such as a visually challenged and/or technologically challenges user, or even a user without such challenges, can now easily parse through the search results to identify one or more digital assets of interest.

In some embodiments and as will be discussed in further detail, for the feature selection process discussed herein, the reduction in the search results is much higher than it would have been for a random feature selection process. Put differently, the feature selection process discussed herein has a relatively high probability of greater reduction in the search results, compared to what is likely to be achievable via random selection of the feature. Thus, the interaction between the user and the search system is based on dynamic and intelligent selection of features, rather than any random selection of features. Such dynamic and intelligent selection of features ensures higher probability of relatively higher reduction in the search results with a relatively fewer number of interactions between the user and the search system. This results in a better, quicker, and more streamlined search experience for a user. Numerous variations and embodiments will be appreciated in light of this disclosure.

System Architecture and Example Operation

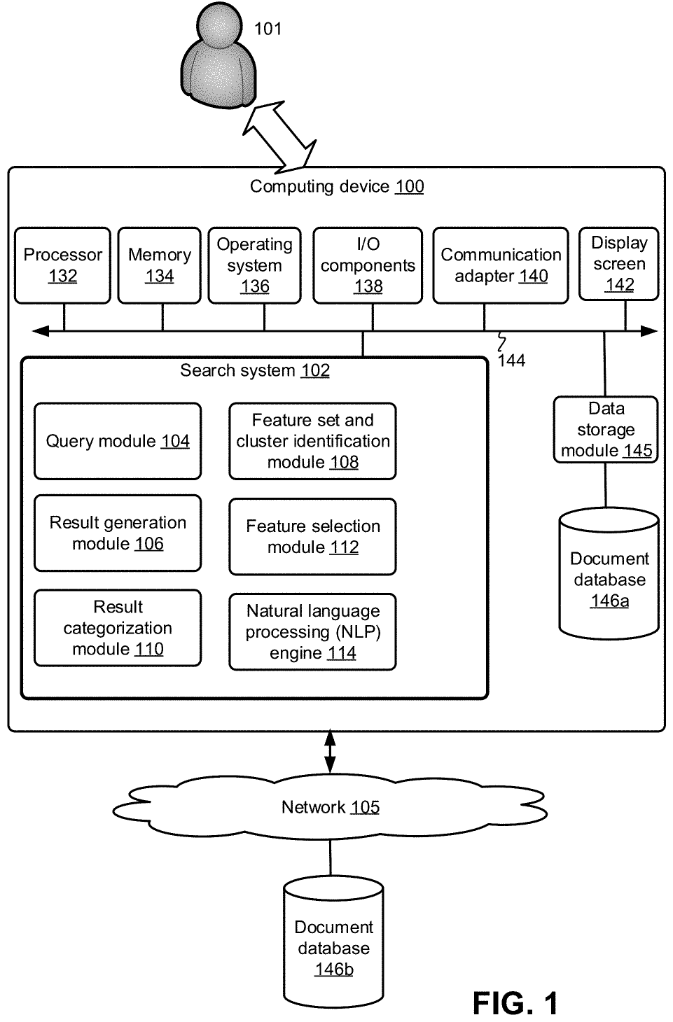

FIG. 1 is a block diagram schematically illustrating selected components of an example computing device 100 (also referred to as device 100) configured to conduct a search process for digital documents, and narrow the search process by selecting an appropriate query, in accordance with some embodiments of the present disclosure. As can be seen, the device 100 includes a search system 102 (also referred to as system 102) that allows the device 100 to conduct a search process for digital assets or documents, and to narrow the search process based on selecting and executing an appropriate query. As will be appreciated, the configuration of the device 100 may vary from one embodiment to the next. To this end, the discussion herein will focus more on aspects of the device 100 that are related to facilitating a search process, and dynamically narrowing the search process, and less so on standard componentry and functionality typical of computing devices.

The device 100 can comprise, for example, a desktop computer, a laptop computer, a workstation, an enterprise class server computer, a handheld computer, a tablet computer, a smartphone, a set-top box, a game controller, and/or any other computing device that can facilitate a search process.

In the illustrated embodiment, the device 100 includes one or more software modules configured to implement certain functionalities disclosed herein, as well as hardware configured to enable such implementation. These hardware and software components may include, among other things, a processor 132, memory 134, an operating system 136, input/output (I/O) components 138, a communication adaptor 140, data storage module 114, and the search system 102. A document database 146a (e.g., that comprises a non-transitory computer memory) stores a plurality of document or files (also referred to herein as digital assets), which can be searched by the search system 102. The document database 146a is coupled to the data storage module 114.

In some embodiments, the document database 146a is stored locally within the device 100. In some embodiments, the device 100 (e.g., the search system 102) can also access a remote document database 146b, e.g., via a network 105. The remote document database 146b symbolically illustrates one or more cloud-storage systems accessible to a user 101 of the device 100.

The device 100 is coupled to the network 105 via the adaptor 140 to allow for communications with other computing devices and resources, such as the document database 146b. The network 105 is any suitable network over which the device 100 communicates. For example, network 105 may be a local area network (such as a home-based or office network), a wide area network (such as the Internet), or a combination of such networks, whether public, private, or both. In some cases, access to resources on a given network or computing system may require credentials such as usernames, passwords, or any other suitable security mechanism. In some embodiments, the search system 102 can search for digital documents or assets within the document database 146a and/or the document database 146b.

In some embodiments, the device 100 includes, or is communicatively coupled to, a display screen 142. Thus, in an example, the display screen 142 can be a part of the device 100, while in another example the display screen 142 can be external to the device 100. A bus and/or interconnect 144 is also provided to allow for inter- and intra-device communications using, for example, communication adaptor 140. Note that in an example, components like the operating system 136 and the search system 102 can be software modules that are stored in memory 134 and executable by the processor 132. In an example, at least sections of the search system 102 can be implemented at least in part by hardware, such as by Application-Specific Integrated Circuit (ASIC) or microcontroller with one or more embedded routines. The bus and/or interconnect 144 is symbolic of all standard and proprietary technologies that allow interaction of the various functional components shown within the device 100, whether that interaction actually take place over a physical bus structure or via software calls, request/response constructs, or any other such inter and intra component interface technologies, as will be appreciated.

Processor 132 can be implemented using any suitable processor, and may include one or more coprocessors or controllers, such as an audio processor or a graphics processing unit, to assist in processing operations of the device 100. Likewise, memory 134 can be implemented using any suitable type of digital storage, such as one or more of a disk drive, solid state drive, a universal serial bus (USB) drive, flash memory, random access memory (RAM), or any suitable combination of the foregoing. Operating system 136 may comprise any suitable operating system, such as Google Android, Microsoft Windows, or Apple OS X. As will be appreciated in light of this disclosure, the techniques provided herein can be implemented without regard to the particular operating system provided in conjunction with device 100, and therefore may also be implemented using any suitable existing or subsequently-developed platform. Communication adaptor 140 can be implemented using any appropriate network chip or chipset which allows for wired or wireless connection to a network and/or other computing devices and/or resource. The device 100 also include one or more I/O components 138, such as one or more of a tactile keyboard, a display, a mouse, a touch sensitive display, a touch-screen display, a trackpad, a microphone, a camera, scanner, and location services. In general, other standard componentry and functionality not reflected in the schematic block diagram of FIG. 1 will be readily apparent, and it will be further appreciated that the present disclosure is not intended to be limited to any specific hardware configuration. Thus, other configurations and subcomponents can be used in other embodiments.

Also illustrated in FIG. 1 is a user 101 interacting with the device 100. Although a single user 101 is illustrated, multiple users may interact with the device 100, and such multiple users are symbolically represented using the user 101 in FIG. 1. Although the user's technical and/or search expertise can range from being naïve to being extremely sophisticated, in an example, it is assumed that the user 101 is not technologically sophisticated enough. In another example, it is assumed that the user 101 is visually challenged or visually impaired.

In an example, the user may be searching for one or more specific files in a database, such as the database 146a. The user 101 may initiate the search by inputting one or more keywords. The initial query of the user 101 may result in a relatively large number of search results, whereas the user 101 may be searching for one or more specific files. As discussed herein, in some examples, the user 101 may not be technologically sophisticated enough and/or may be at least partially visually challenged or visually impaired. Accordingly, for these reasons or otherwise, the user 101 may not want to go through the relatively large number of search results. Hence, in some embodiments, the search system 102 facilitates narrowing down the search results, e.g., by interacting with the user 101 and querying the user 101 about the desired results.

For example, the user 101 may be searching for a digital asset that the user 101 had previously accessed, or a digital asset that the user 101 knows is stored in a database. In some embodiments, the search system 102 may enquire about one or more features associated with the digital asset the user 101 is looking for, such as whether the intended digital asset is an audio file, a video file, an image, or a textual digital asset, a last access time (e.g., when the intended digital asset was last accessed), a duration of video of the intended digital asset (e.g., in case the digital asset is a video), and/or any other appropriate feature associated with the intended digital asset.

In some embodiments and as will be discussed in further detail, the search system 102 selects a feature and queries about the selected feature to the user, where the selection of the feature is done intelligently and dynamically. For example, the search system 102 selects a feature, such that an answer to the query about the selected feature has a relatively high probability of reducing the search results by a relatively large amount.

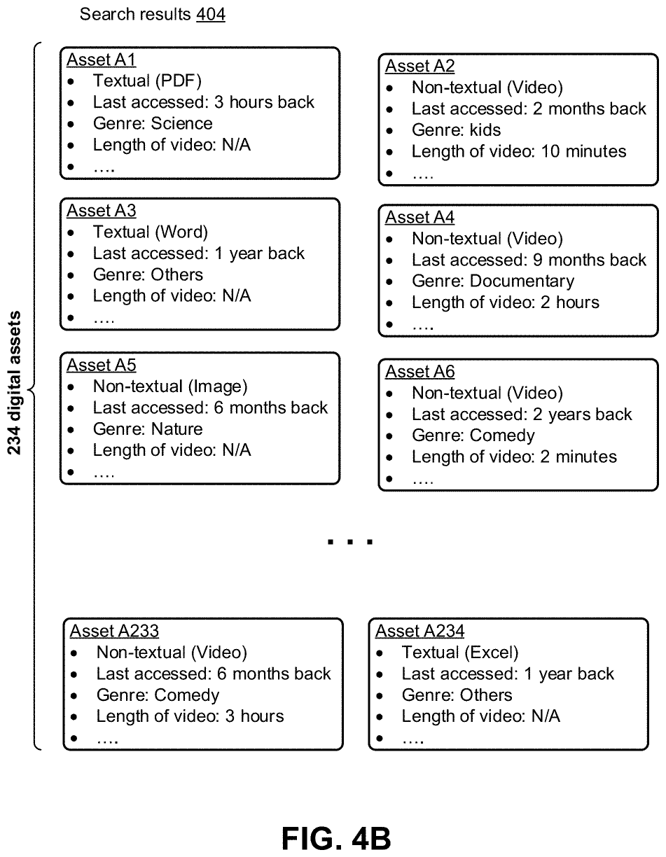

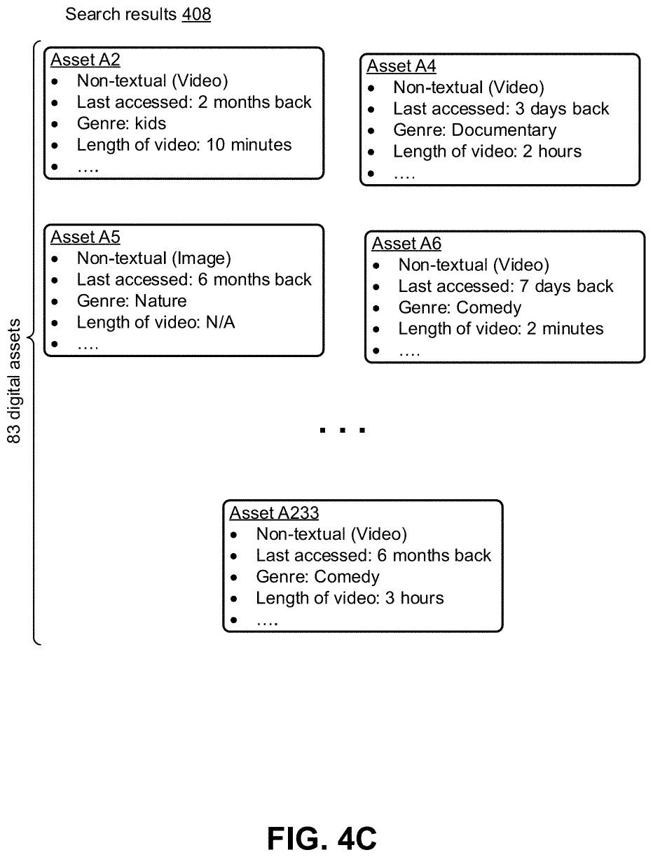

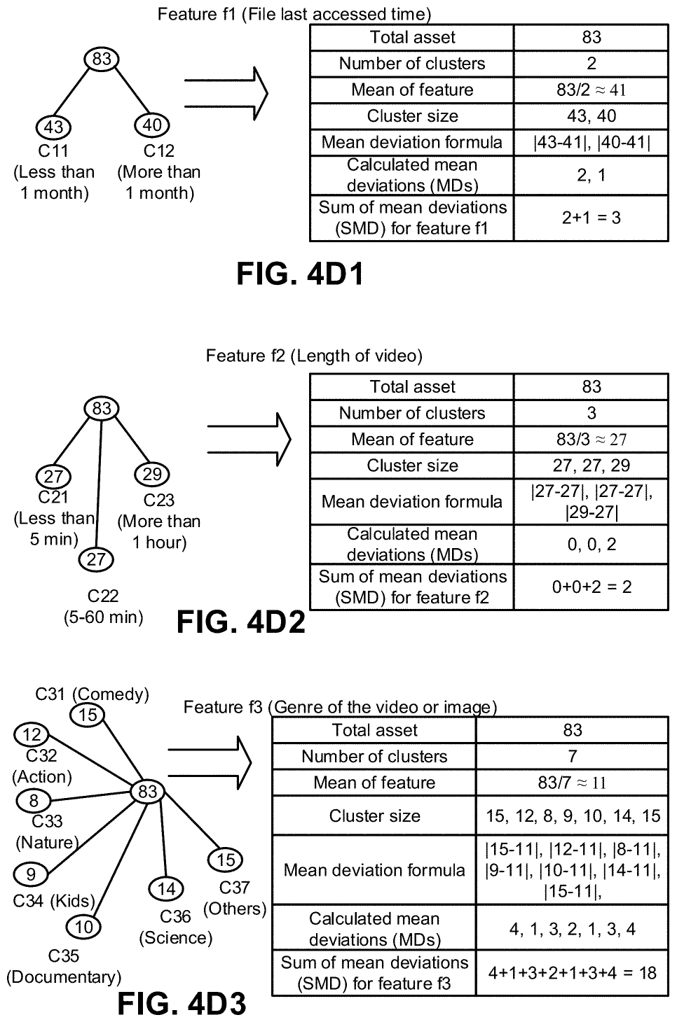

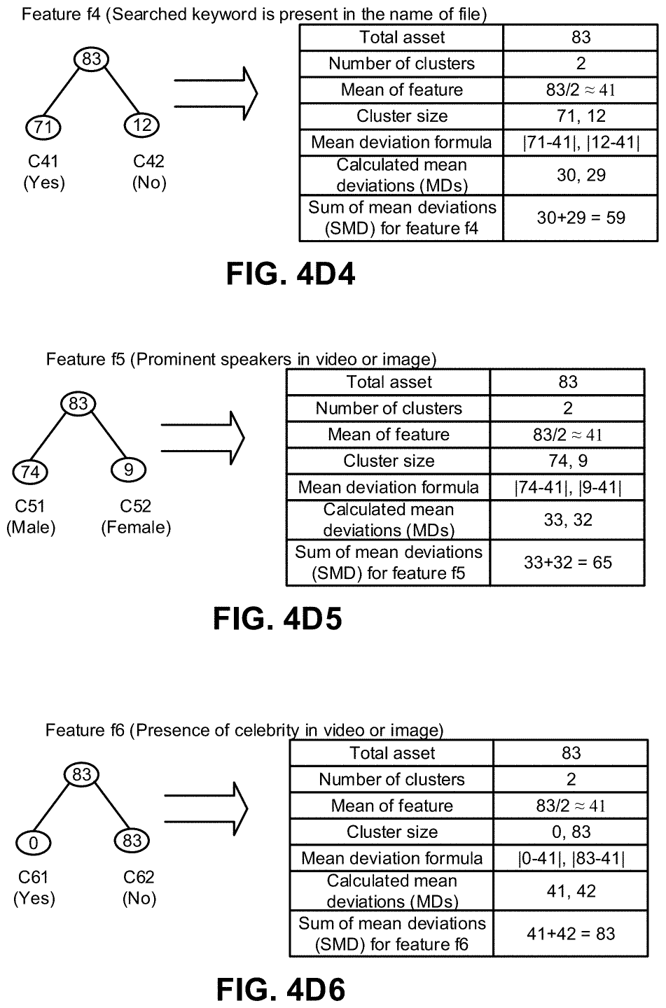

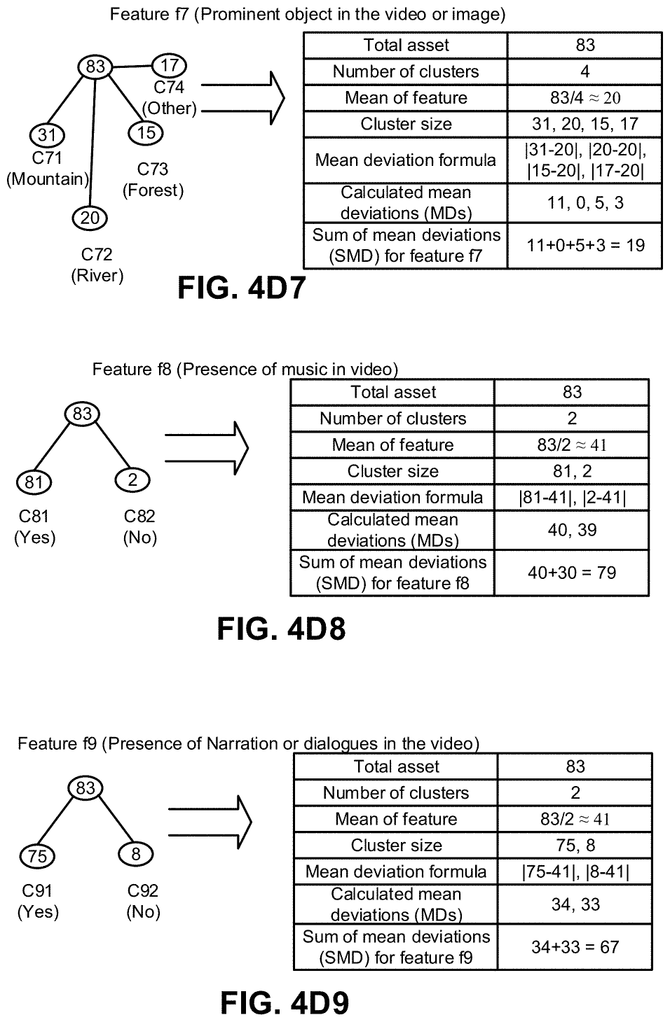

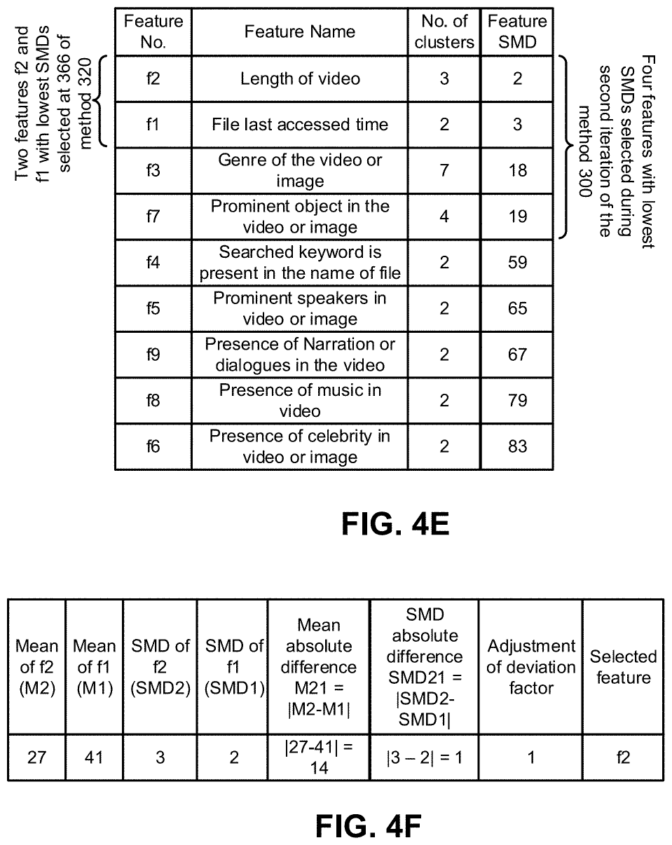

Merely as an example, assume that an initial search results based on a user query has about 234 assets (this example is discussed in further detail with respect to FIG. 4A), and querying the user 101 about a category of the intended digital asset (e.g., whether the intended digital asset is a video, an audio, an image, or a textual file) reduces the search results to include 83 assets. In an example, because of the various reasons discussed herein earlier, it may be difficult for the user 101 to pinpoint the intended digital asset from the search result of 83 assets. Accordingly, the search system 102 aims to further reduce the search results, e.g., by querying the user 101 about a feature of the intended digital asset.

Continuing with the above example where there are 83 search results, the search system 102 can query the user 101 about any of a large number of features, where examples of such features include (i) file last accessed time, (ii) length of the video, (iii) genre of the video, (iv) whether searched keyword is present in the name of file, (v) prominent speaker in the video, (vi) presence of any celebrity in the video or image, (vii) prominent object in the video or image, (viii) presence of music in the video, (ix) presence of narration or dialogues in the video, and/or the like, where these example features are discussed in further detail with respect to Table 1 herein later. As will be discussed in further detail, in an example, the search system predicts that querying the user 101 and getting answer from the user 101 about “file last accessed time” is going to reduce the search asset to X1, versus getting answer from the user 101 about “length of the video” is going to reduce the search asset to X2. Assume that X2 is likely to be less than X1. In such a scenario, the search system 102 selects the “length of the video” feature, and queries the user 101 regarding the length of the video.

Once the search system 102 receives an answer from the user 101 regarding the length of the video that the user 101 is looking for, the search system 102 reduces the number of search results, based on the received answer. For example, the user 101 can specify that the length of the video is greater than an hour, and the search system 102 refines the search results to only include videos that are greater than an hour.

This process of interaction between the user 101 and the search system 102 continues, until the number of search results is sufficiently small (e.g., less than a threshold). During each turn of the interaction between the user 101 and the search system 102, the search system 102 selects a feature using in the above discussed manner. For example, the search system 102 selects a feature from multiple possible features, such that query and response from the user about the selected feature is likely to minimize the reduction in the search results. That is, at each iteration turn, the aim of the feature selection process is to minimize the reduction in the search results based on user response about the selected feature.

During this iterative process, once a number of search results is sufficiently small (e.g., less than a threshold), the search system 102 presents (e.g., displays, presents through an audible voice, etc.) the search results to the user 101. As the number of search results is sufficiently small, the user 101 now can relatively easily go through the search results, to find the intended digital asset.

Illustrated in FIG. 1 is the search system 102 implemented on the device 100. In some embodiments, the system 102 includes a query module 104 for presenting query to the user 101 via the device 100, and a result generation module 106 to search one or more databases to generate search results. In some embodiments, the system 102 further includes a result categorization module 110 to categorize the search results in various clusters of various features, a feature set and cluster identification module 108 to identify one or more features and one or more clusters of individual features, and a feature selection module 112 to select a feature among multiple features. In some embodiments, the system 102 further includes a natural language processing (NLP) engine 114. For example, the user 101 may interact with the device 100 via voice or gestures, and the NLP engine 114 may translate such input of the user 101 to a machine language understandable to the search engine 102. Each of the components of the search system 102 will be discussed in further detail herein later.

The components of the search system 102 can be in communication with one or more other devices including other computing devices of a user, server devices (e.g., cloud storage devices), licensing servers, or other devices/systems. Although the components of the system 102 are shown separately in FIG. 1, any of the subcomponents may be combined into fewer components, such as into a single component, or divided into more components as may serve a particular implementation.

In an example, the components of the system 102 performing the functions discussed herein with respect to the system 102 may be implemented as part of a stand-alone application, as a module of an application, as a plug-in for applications, as a library function or functions that may be called by other applications, and/or as a cloud-computing model. Thus, the components of the system 102 may be implemented as part of a stand-alone application on a personal computing device or a mobile device. Alternatively, or additionally, the components of the search system 102 may be implemented in any application that allows digital content processing and displaying.

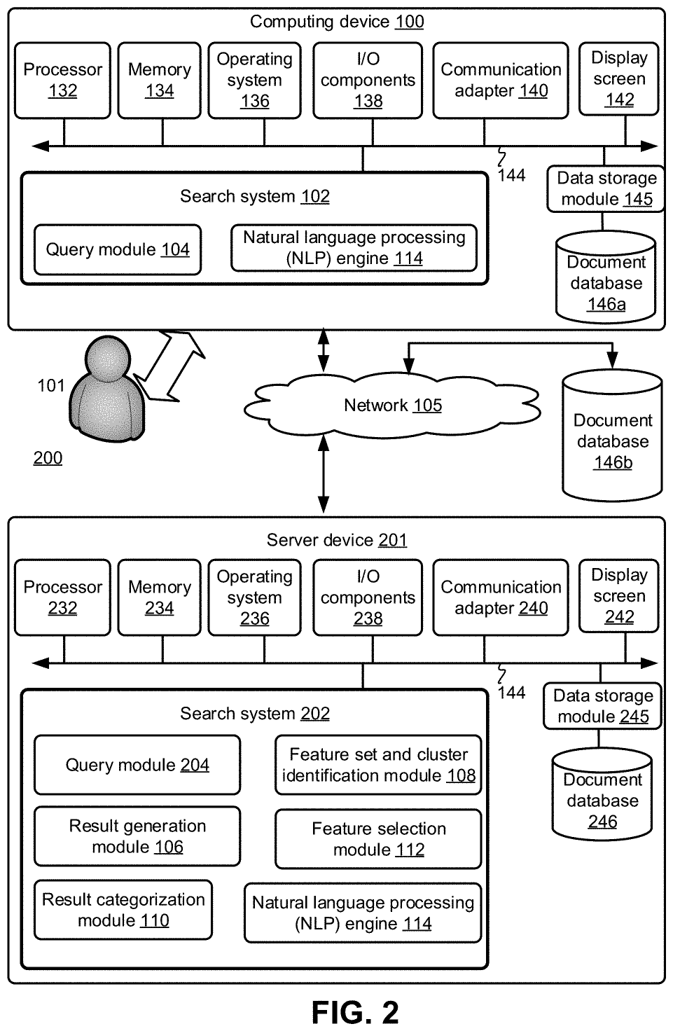

FIG. 2 is a block diagram schematically illustrating selected components of an example system 200 comprising the computing device 100 of FIG. 1 communicating with server device(s) 201, where the combination of the device 100 and the server device(s) 201 (henceforth also referred to generally as server 201) are configured to conduct a search process for digital documents, and narrow the search process by selecting an appropriate query, in accordance with some embodiments of the present disclosure.

In one embodiment, the server 201 comprises one or more enterprise class devices configured to provide a range of services invoked to provide aside identification services and content ordering, as variously described herein. Examples of such services include receiving a search request, generating search results, identifying a plurality of features associated with the search results, selecting a feature among the plurality of features, querying the user 101 about the selected feature, receiving a response from the user, refining and reducing the search results, and iteratively repeating the process to further reduce the search results if needed. Although one server 201 implementation of the search system is illustrated in FIG. 2, it will be appreciated that, in general, tens, hundreds, thousands, or more such servers can be used to manage an even larger number of search queries.

In the illustrated embodiment, the server 201 includes one or more software modules configured to implement certain of the functionalities disclosed herein, as well as hardware configured to enable such implementation. These hardware and software components may include, among other things, a processor 232, memory 234, an operating system 236, a search system 202 (also referred to as system 202), data storage module 245, and a communication adaptor 240. A document database 246 (e.g., that comprises a non-transitory computer memory) comprises multiple documents that can be searched by the search system 202, and is coupled to the data storage module 245. A bus and/or interconnect 244 is also provided to allow for inter- and intra-device communications using, for example, communication adaptor 240 and/or network 205. Note that components like the operating system 236 and search system 202 can be software modules that are stored in memory 234 and executable by the processor 232. The previous relevant discussion with respect to the symbolic nature of bus and/or interconnect 144 is equally applicable here to bus and/or interconnect 244, as will be appreciated.

Processor 232 is implemented using any suitable processor, and may include one or more coprocessors or controllers, such as an audio processor or a graphics processing unit, to assist in processing operations of the server 201. Likewise, memory 234 can be implemented using any suitable type of digital storage, such as one or more of a disk drive, a universal serial bus (USB) drive, flash memory, random access memory (RAM), or any suitable combination of the foregoing. Operating system 236 may comprise any suitable operating system, and the particular operation system used is not particularly relevant, as previously noted. Communication adaptor 240 can be implemented using any appropriate network chip or chipset which allows for wired or wireless connection to network 205 and/or other computing devices and/or resources. The server 201 is coupled to the network 205 to allow for communications with other computing devices and resources, such as the device 100. In general, other componentry and functionality not reflected in the schematic block diagram of FIG. 2 will be readily apparent in light of this disclosure, and it will be further appreciated that the present disclosure is not intended to be limited to any specific hardware configuration. In short, any suitable hardware configurations can be used.

The server 201 can generate, store, receive, and transmit any type of data, including search results and/or queries associated with the search process. As shown, the server 201 includes the search system 202 that communicates with the search system 102 on the client device 100. In an example, the search features discussed with respect to FIG. 1 can be implemented in FIG. 2 exclusively by the search system 102, exclusively by the search system 202, and/or may be shared between the search systems 102 and 202. Thus, in an example, none, some, or all search features are implemented by the search system 202.

For example, when located in the server 201, the search system 202 comprises an application running on the server 201 or a portion of a software application that can be downloaded to the device 100. For instance, the system 102 can include a web hosting application allowing the device 100 to interact with content from the system 202 hosted on the server 201.

Thus, the location of some functional modules in the system 200 may vary from one embodiment to the next. Any number of client-server configurations will be apparent in light of this disclosure. In still other embodiments, the techniques may be implemented entirely on a user computer, e.g., simply as stand-alone aside detection and content ordering application. Similarly, while the document database 146a and the document database 246 are shown on the client and server side, respectively, in this example case, it may be exclusively on the server side in other embodiments, or be a cloud-based document database 146b. Thus, the document databases can be local or remote to the device 100, so long as it is accessible by the search system 102 and/or the search system 202.

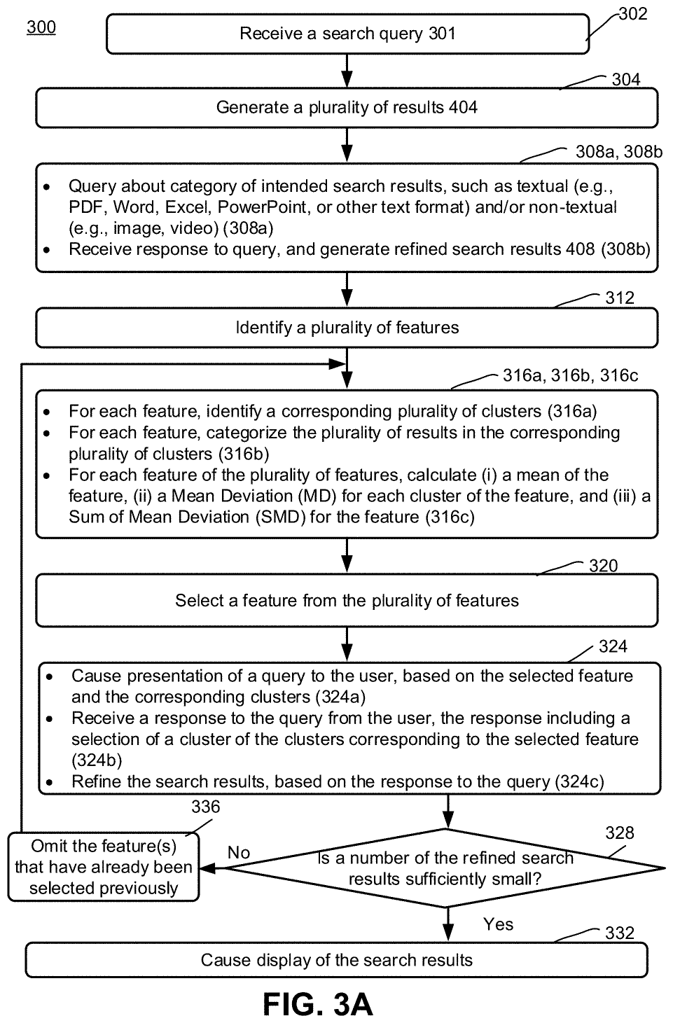

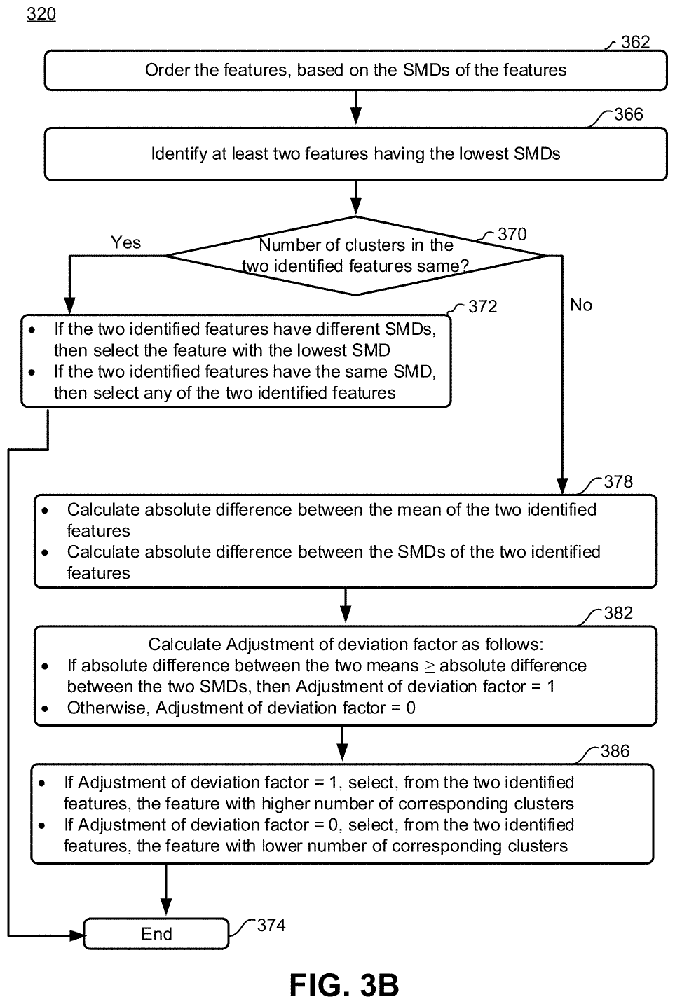

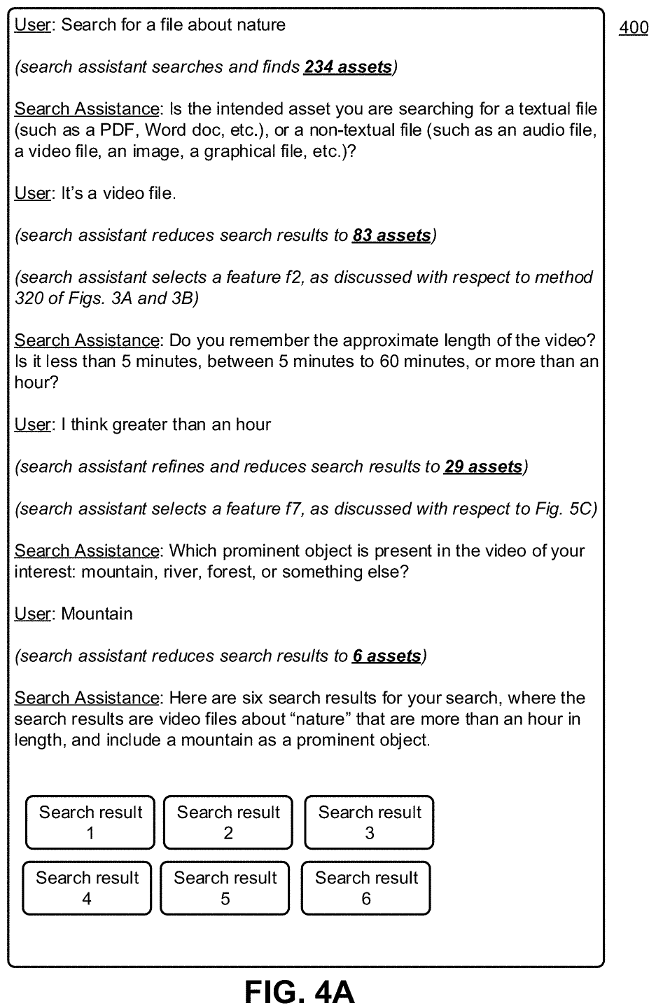

FIG. 3A is a flowchart illustrating an example method 300 for facilitating a search process, and narrowing the search process using selective query, in accordance with some embodiments of the present disclosure. Method 300 can be implemented, for example, using the system architecture illustrated in FIGS. 1 and/or 2, and described herein, e.g., using the search systems 102 and/or 202. However other system architectures can be used in other embodiments, as apparent in light of this disclosure. To this end, the correlation of the various functions shown in FIG. 3A to the specific components and functions illustrated in FIGS. 1 and 2 is not intended to imply any structural and/or use limitations. Rather, other embodiments may include, for example, varying degrees of integration wherein multiple functionalities are effectively performed by one system. In another example, multiple functionalities may be effectively performed by more than one system. For example, in an alternative embodiment, a first server may facilitate the search process and provide search results, and a second server may select query for narrowing the search process. In yet another embodiment, a client device (such as device 100, instead of a server) may present the query to a user, and receive response from the user. Thus, various operations of the method 300 are discussed herein as being performed by the system 102 of the computing device 100 and/or the system 202 of the server 201.

FIG. 4A illustrates an example interaction 400 between a user 101 and a search assistant implemented by the search system 102 of FIGS. 1 and 2, in accordance with some embodiments of the present disclosure. The texts that are italicized and with brackets in FIG. 4A are not a part of actual interaction between the user 101 and the search system 102—rather, such texts discuss various internal operations performed by the search system 102 in the background. The method 300 of FIG. 3A and the interaction 400 of FIG. 4A will be discussed in unison herein.

Referring to FIG. 3A, in some embodiments, the method 300 comprises, at 302, receiving a search query 301. The search query 301 can be received, for example, by the query module 104 of the device 100 from the user 101. This is, for example, illustrated in FIG. 4A as a user query “Search for a file about nature.” In an example, the user 101 interacts with the device 100 (e.g., with the query module 104 of the search system 102 of the device 100), to input the search query 301 to the device 100. In an example, the user 101 types the search query 301 using an input device (such as a keyboard) of the device 100. In another example, the user 101 inputs the search query 301 using a voice command, which the NLP engine 114 translates to a machine language that is understandable to various components of the search system 102. In yet another example, the user 101 inputs the search query 301 using a gesture (such as a hand gesture, a sign-language gesture that is used by a visually challenged person, or another appropriate gesture), and a camera or other sensing system of the device 100 captures the gesture.

In an example, the user 101 may be searching for a digital asset that the user 101 had previously accessed, or a digital asset that the user 101 knows is stored in a database (such as database 146a and/or 146b). As discussed, in an example, the search query 301 can be to search among digital assets stored within the user's local computing device, such as the device 100, in which case the search is conducted within the database 146a. In another example, the search query 301 can be to search among digital assets stored in a specific remote location (such as a cloud-based storage), in which case the search is conducted within the databases 146b and/or 246, where these databases represent cloud-based digital assets. In yet another example, the search query 301 can be to search among digital assets stored, for example, in the World Wide Web, e.g., the Internet, in which case the search is conducted within the databases 146b and/or 246.

The method 300 then proceeds to 304, where the result generation module 106 generates search results 404. In the example interaction 400 of FIG. 4A, the result generation module 106 searches and finds, merely as an example, 234 number of digital assets that match the initial search query of the user 101 (shown in italicized text with brackets in FIG. 4A). It may be noted that the 234 search results in FIG. 4A is merely an example, and hundreds, thousands, tens of thousands, or even more search results can be identified. FIG. 4B symbolically illustrates digital assets identified by the result generation module 106 at 304 of the method 300, in accordance with some embodiments of the present disclosure. The search results 404 of FIG. 4B are generated based on the search query 304. To be consistent with the example of FIG. 4A, in FIG. 4B a total of 234 number of assets are symbolically indicated.

In some embodiments, because of the large number of search results identified in 304, it can be difficult to display all the search results. For example, if all 234 search results are displayed, the user has to view individual ones of the 234 search results, to find the desired file. In an example, this can be especially challenging for a visually impaired or challenged user and/or a user who is not technologically sophisticated. Thus, the search systems 102, 202 systematically and dynamically aim to reduce the number of search results, e.g., by intelligently interacting with the user 101 and narrowing down the search process.

In some embodiments, the result categorization module 110 categorizes individual ones of the digital assets A1, . . . , AN of the search results 404 as being either a textual digital asset, or a non-textual (e.g., video, image, graphical, audio) digital asset. Merely as an example, textual digital assets include document types that primarily include texts. Examples of such textual document types include, not is not limited to, PDF (a Portable Document Format), word document, excel sheet, power point documents, and/or other appropriate text format types (such as .txt). On the other hand, non-textual digital assets include document types that primarily include images, videos, audio, etc. Examples of such non-textual document types include, not is not limited to, audio files, video filed, image files.

Referring again to FIG. 3A, the method 300 proceeds from 304 to 308, where 308 has two sub-steps 308a, 308b. For example, at 308a, the query module 104 and/or 204 query the user 101 about a category of intended search results, such as whether the intended search result is textual or non-textual. For example, if the intended search result is textual (such as PDF, word, excel, power point, or other text format), a desired response would be textual. On the other hand, if the intended search result is to be non-textual (such as an audio file, a video file, an image), a desired response would be non-textual. Merely as an example, the query at 308a can be: “Is the intended asset you are searching for an audio, a video, an image, or a textual file?” In another example, the query at 308a can be: “Is the intended asset you are searching for a textual file, or a non-textual file (such as audio, a video, an image)?”, as illustrated in the example interaction 400 of FIG. 4A.

At 308b, the query module 104 and/or 204 receives a response from the user regarding a category of the asset the user is looking for. For example, the user can specify whether the desired search result is textual or non-textual. Merely as an example, the user may respond that the file that is being searched is graphical in nature (specifically, a video), as illustrated in the example interaction 400 of FIG. 4A. Various examples presented herein assumes the searched file is graphical or otherwise non-textual, although such examples are not intended to limit the scope of this disclosure. In the example of FIG. 4A, based on this response, the search system 102 narrows or refines the search results to include, for example, 83 digital assets. The refined search results are labelled as search result 408 in FIGS. 3A and 4C.

FIG. 4C symbolically illustrates search results 408 that are refined based on categorization of the intended digital assets as being one of textual or non-textual, in accordance with some embodiments of the present disclosure. For example, 83 digital assets (e.g., A2, A4, A5, A6, . . . , A233) are identified as search results 408, based on the user 101 identifying graphical (a video, in this example case), as being the search category, where 83 is the number of search results after refining the search results at 308b of method 300. The 83 assets responsive to the search are also discussed with respect to FIG. 4A in italics and within brackets. As discussed with respect to FIG. 4A, the number 83 is merely an example, and does not limit the scope of this disclosure.

In an example, because of the various reasons discussed herein earlier, it may be difficult for the user 101 to pinpoint the intended digital asset from the search result of 83 assets (i.e., the 83 digital assets may be too many for presenting to the user 101). Accordingly, the search system 102 aims to further reduce the search results, e.g., by selecting a feature and querying the user 101 about the selected feature of the intended digital asset.

In some embodiments, the method 300 of FIG. 3A proceeds from 308b to 312, where the feature set and cluster identification module 108 identifies various attributes or features of individual ones of the digital assets A1, . . . , A83. Examples of some features that may be identified by the feature set and cluster identification module 108 are listed in Table 1. In Table 1, the various features are identified as a feature set F={f1, f2, f3, f4, f5, f6, f7, f8, f9}. The features listed in Table 1 are merely examples, and the list is not exhaustive. Thus, the feature set F can include any appropriate number of features.

TABLE 1

| No. | Feature Example | Example Clusters |
|---|---|---|
| f1 | File last accessed time | (C11) Less than a month, |
| | | (C12) more than one month |
| f2 | Length of the video | (C21) less than 5 minutes, |
| | | (C22) 5-60 minutes, |
| | | (C23) more than 1 hour |
| f3 | Genre of the video | (C31) Comedy, (C32) Action, |
| | or image | (C33) Nature, (C34) Kids, |
| | | (C35) Documentary, |
| | | (C36) Science, (C37) others |
| f4 | Searched keyword is | (C41) Yes, (C42) No |
| | present in the name | |
| | of file | |
| f5 | Prominent speakers in the | (C51) male, (C52) female |
| | video or image | |
| f6 | Presence of any celebrity | (C61) Yes, (C62) No |
| | in the video or image | |
| f7 | Prominent object in the | (C71) Mountain, (C72) River, |
| | video or image | (C73) Forest (e.g., when the |
| | | initial search query is for |
| | | “nature”), (C74) Other |
| f8 | Presence of music in the | (C81) Yes, (C82) No |
| | video | |
| f9 | Presence of Narration or | (C91) Narration, (C92) Dialogue |
| | dialogues in the video | |

For example, as illustrated in FIG. 4B, the result categorization module 110 identifies that the digital asset A1 found in the search results 404 is a textual document (such as a PDF document), was last accessed 3 hours back, has a genre of “Science,” and so on. Note that feature “length of video” is not relevant to the textual document type of the asset A1, and hence, is identified as “Not Applicable” (N/A) in FIG. 4.

The method 300 then proceeds to 316, which has three sub-steps 316a, 316b, 316c. At 316a, the feature set and cluster identification module 108 identifies, for each feature, a corresponding plurality of clusters. In some embodiments, a cluster of a feature represents a corresponding range or value of the feature. For example, Table 1 depicts various example clusters corresponding to various example features. Merely as an example, for feature f1 (File last accessed time), the clusters are (C11) Less than a month, and (C12) more than a month, as depicted in Table 1. In another example, for feature f2 (Length of the video), the clusters are (i) less than 5 minutes, (ii) 5-60 minutes, (iii) more than 1 hour, as depicted in Table 1. Example clusters of various other features are also depicted in Table 1. Of course, the numerical ranges or values of the clusters in Table 1 are merely examples, and do not limit the scope of this disclosure.

For example, for each feature fi (where i=1, . . . , 9 for the example of Table 1), a corresponding plurality of clusters Cia, Cib, and so on are identified. In general,

fi={Cia,Cib, . . . }, where i=1, . . . , 9 for the example of Table 1 Equation 1a

Thus, Table 1 identifies the following clusters for the features:

f1={C11,C12}

f2={C21,C22,C23}

f3={C31,C32,C33,C34,C35,C36,C37}

f4={C41,C42}

f5={C51,C52}

f6={C61,C62}

f7={C71,C72,C73,C74}

f8={C81,C82}

f9={C91,C92} Equations 1b

The method 300 then proceeds from 316a to 316b, where for each feature, the feature set and cluster identification module 108 categorizes the digital assets of the search results in the corresponding plurality of cluster. For example, the 83 assets of FIG. 4C are categorized among various assets of feature f1, are categorized among various assets of feature f2, are categorized among various assets of feature f3, and so on.

For a given feature, the cluster in which a given asset is categorized is determined in any appropriate manner. For example, metadata information of a digital asset can provide information about at least some of the features, such as file last accessed time, length of video, and/or whether searched keyword is present in the name of file. So, if the metadata information indicates that the last accessed time for a digital asset is 5 days (e.g., the file was last accessed 5 days back), the digital asset is categorized in cluster C11 of feature f1.

In some embodiments, the feature set and cluster identification module 108 may also go through the contents of the digital assets to determine clusters for features like prominent object in the video or image, prominent speakers in the video or image, presence of music in the video, genre of the video, and so on. For example, the feature set and cluster identification module 108 may use a trained Neural Network model to identify such features of the digital assets, and categorize the assets accordingly.

In yet another example, the user 101, while saving and/or accessing a file, saves metadata including information associated with one or more features. For example, if a video or an image is primarily about mountains, the user 101 saves such information, and the feature set and cluster identification module 108 is aware that the feature f7 (Prominent object in the video or image) has a value of mountain. Then, for the feature f7, the file is categorized in cluster C71 (Mountains).

In some embodiments, for a given feature, the underlying clusters are mutually exclusive to each other. For example, if an asset is categorized to be within a first cluster of a first feature, the asset cannot be categorized to be within any other cluster of the first feature. That is, an asset cannot be present in more than one cluster of a specific feature. For example, if an asset Ap is present in cluster Cia of a feature fi, then this asset Ap cannot be present in another cluster Cib of same feature fi. Thus,

for feature fi={Cib, . . . }, if ∃ Ap in Cim, then [symbol] Ap in Cin Equation 2

However, an asset present in a cluster of a first feature will be present in another cluster of another feature. For example, referring to FIG. 4C and Table 1, the asset A2 is present in cluster C12 (more than 1 month) of the feature f1 (File last accessed time). The same asset A2 is also present in cluster C22 (5-60 minutes) of the feature f2 (Length of the video). The same asset A2 is also present in cluster C34 (Kids) of the feature f3 (Genre of the video or image), and so on.

Assume that the assets are categorized as follows:

f1={P11 assets in cluster C11, P12 assets in cluster C12}

f2={P21 assets in cluster C21, P22 assets in cluster C22, P23 assets in cluster C23}

f3={P31 assets in cluster C31, P32 assets in cluster C32, . . . P37 assets in cluster C37}

f4={P41 assets in cluster C41, P42 assets in cluster C42}

f5={P51 assets in cluster C51, P52 assets in cluster C52}

f6={P61 assets in cluster C61, P62 assets in cluster C61}

f7={P71 assets in cluster C71, . . . P74 assets in cluster C74}

f8={P81 assets in cluster C81, P82 assets in cluster C82}

f9={P91 assets in cluster C91, P92 assets in cluster C92} Equations 3

Thus, for feature f1, P11 numbers of assets are categorized into cluster C11, and P12 numbers of assets are categorized into cluster C12. Similarly, for feature f2, P21 numbers of assets are categorized into cluster C21, P22 numbers of assets are categorized into cluster C22, and P23 numbers of assets are categorized into cluster C23. It may be noted that P11+P12=83 in the example of FIGS. 4A and 4C. Similarly, P21+P22+P23=83; P31+P32+P33=83; and so on.

It may be noted that the clusters are generated and the search results categorized dynamically and on the fly. For example, in the examples discussed herein, the user 101 initially searched for “nature,” and hence, the feature f7 (Prominent object in the video or image) has clusters (C71) Mountain, (C72) River, (C73) Forest, (C74) Other. However, when the initial search query is changed, the clusters for this feature may also change correspondingly. For example, if the initial search query is about animals, the clusters corresponding to feature f7 can be cats, dogs, elephants, bears, and so on.

The method 300 then proceeds from 316b to 316c, where for each feature, a corresponding “Mean of the feature” is calculated as follows:

$$Mean of a given feature = \frac{Total number of assets}{\begin{matrix}Total number of clusters for the \\ given feature\end{matrix}} \qquad Equation 5$$

For example, assuming the total number of assets to be 83 (e.g., as discussed with respect to FIGS. 4A and 4C), the “Mean of feature” for various features are depicted in Table 2 below.

TABLE 2

| No. | Feature Example | Clusters | Mean of feature |
|---|---|---|---|
| f1 | File last accessed time | C11, C12 | 83/2 ≈ 41 |
| f2 | Length of the video | C21, C22, C23 | 83/3 ≈ 27 |
| f3 | Genre of the video or | C31, C32, C33, | 83/7 ≈ 11 |
| | image | C34, C35, C36, C37 | |
| f4 | Searched keyword is | C41, C42 | 83/2 ≈ 41 |
| | present in the name | | |
| | of file | | |
| f5 | Prominent speakers in | C51, C52 | 83/2 ≈ 41 |
| | the video or image | | |
| f6 | Presence of any celebrity | C61, C62 | 83/2 ≈ 41 |
| | in the video or image | | |
| f7 | Prominent object in the | C71, C72, C73, C74 | 83/4 ≈ 20 |
| | video or image | | |
| f8 | Presence of music in the | C81, C82 | 83/2 ≈ 41 |
| | video | | |
| f9 | Presence of Narration or | C91, C92 | 83/2 ≈ 41 |
| | dialogues in the video | | |

Referring again to the method 300 of FIG. 3A, also at 316c, for each feature, Mean Deviations (MD) for various clusters are then calculated. For example, for each feature, the MDs for all the clusters of the corresponding feature are calculated. The MD of a cluster of a feature is an indication of how much a given cluster size deviates from the mean of the corresponding feature. In some embodiments, the MD for a cluster is calculated as follows:

MD of a cluster=|(size of the cluster)−(Mean of the feature to which the cluster belongs)| Equation 6

In equation 6 and various other equations, the |⋅| operator is for denoting absolute value, without regarding the sign of the difference. The size of the cluster (also referred to as “cluster size”) refers to a number of digital assets categorized within the cluster.

FIGS. 4D1, 4D2, 4D3, 4D4, 4D5, 4D6, 4D7, 4D8, and 4D9 respectively illustrate example Mean Deviations (MD) calculations for various clusters for features f1, f2, f3, f4, f5, f6, f7, f8, and f9, respectively, in accordance with some embodiments of the present disclosure. Total assets in each of FIGS. 4D1-4D9 is 83, which can be the search results 408 discussed with respect to operation 308b of the method 300 and also discussed with respect to FIG. 4C. For example, referring to FIG. 4D1, this figure is for feature f1 (File last accessed time). As discussed with respect to Table 1, there are two clusters for feature f1: C11 (Less than a month), and C12 (more than one month). In the example of FIG. 4D1, 43 of the 83 digital assets are categorized in cluster C11, and 40 of the 83 digital assets are categorized in cluster C12. The mean of feature f1 is 83/2≈41, as discussed with respect to Table 2 and as also illustrated in FIG. 4D1. The Mean Deviation or MD for cluster C11 is |43-41|, i.e., 2. The MD for cluster C12 is |40-41|, i.e., 1. Similarly, example MDs for clusters for various other features are illustrated in FIGS. 4D2-4D9.

Referring again to the method 300 of FIG. 3A, also at 316c, once the MDs for various clusters of various features are calculated, a Summation of Mean Deviations (SMD) for each feature is then calculated. For example, for a specific feature, the SMD is a summation of the MDs for various clusters of the feature. For example, for feature fi (where i=1, . . . , 9 for the example of Table 1), assume the corresponding clusters are {Ci1, Ci2, . . . , Cix}, where the clusters have mean deviations as {MDi1, MDi2, MDix}. Then the SMD for feature fi is computed as:

SAID of feature fi=MDi1+MDi2+ . . . +MAix Equation 6

FIGS. 4D1, 4D9 also illustrate the SMDs for features f1, . . . , f9, respectively. For example, referring to FIG. 4D1, the MDs for clusters C11 and C12 of feature f1 are calculated to be 2 and 1, respectively. Accordingly, the SMD for feature f1 is (2+3), i.e., 3. Similarly, example SMDs for various other features are illustrated in FIGS. 4D2-4D9.

Thus, at the end of 316, there are multiple features, such as example features f1, f9 discussed in various example figures herein, MDs for each cluster of each feature, and mean and SMD of each feature. The method 300 then proceeds to 320, where the feature selection module 112 selects a feature from among the multiple features. As will be discussed in further details, the feature selection module 112 selects the feature that is likely to be most efficient in reducing the number of search results, when the search results are refined based on a user response on the selected feature. FIG. 3B illustrates further details of an example feature selection process that can be used at 320 of the method 300 of FIG. 3A, in accordance with some embodiments of the present disclosure.

At a high level, the method 320 of FIG. 3B aims to determine Asset Distribution Value (ADV) for each feature. For example, the method 320 of FIG. 3B aims to determine, for a given feature, how fairly or evenly or uniformly the assets are distributed in various clusters of the feature. A more even or more uniform distribution of assets among different clusters of a feature tends to have a better ADV. The aim of the method 320 is to select a feature with relatively better asset distribution. Doing so increases a probability that the selected feature is likely to be most efficient in reducing the number of search results, when the search results are refined based on a user response to a query about the selected feature.

Referring to FIG. 3B, at 362, the feature selection module 112 orders the features based on the corresponding SMDs. For example, FIG. 4E illustrates the example features f1, . . . , 9 being ordered in an ascending order, based on the corresponding SMDs, in accordance with some embodiments of the present disclosure. For example, the SMDs in FIG. 4E correspond to the SMDs calculated in FIGS. 4D1-4D9.

At 366, at least two features having the lowest SMDs among all the features are identified by the feature selection module 112. Thus, for the example of FIG. 4E, feature f2 having SMD of 2 and feature f1 having SMD of 3 are selected.

As discussed, the SMD being low for a feature implies that the assets are relatively evenly distributed among the clusters of the feature. For example, as illustrated in FIG. 4D1, for feature f1, 43 assets are in cluster C11 and 40 assets are in cluster C12—thus, the assets are somewhat evenly distributed and the feature f1 has relatively low SMD of 3. In contrast, as illustrated in FIG. 4D9, for feature f9, 75 assets are in cluster C91 and 8 assets are in cluster C92—thus, the assets are relatively unevenly distributed and the feature f9 has relatively high SMD of 67. Thus, an SMD of a feature is an indication of how evenly the assets are distributed among the clusters of the feature—more even distribution tends to lower the SMD. In essence, SMDs are a good indication of the above discussed Asset Distribution Values (ADV) for various features. Accordingly, the 366, two or more features with lowest SMDs are selected, which implies that two more ore features with most even asset distributions are selected at 366.

At 370, the feature selection module 112 checks to determine if a number of clusters in the two identified features are the same. In the example of FIGS. 4D1-4D9, 4E and Table 1, the identified features f2 and f2 have 2 clusters and 3 clusters, respectively, and hence, the numbers of clusters are different in this example (although in other example scenarios, the numbers can be the same).

If “yes” at 372 (e.g., if the two identified features had the same number of clusters), then the method 320 proceeds to 372. At 372, if the two identified features have different SMDs, then the feature selection module 112 selects the feature with the lowest SMD. On the other hand, if the two identified features have the same SMD, then the feature selection module 112 can select any of the two identified features. For example, assume features fa and fb having SMDa and SMDb, respectively, are identified at 366, where features fa and fb have the clusters Na and Nb, respectively. Then at 372, the following operations are performed:

Assuming Na==Nb (i.e., “yes” at 370)

If SMDa<SMDb, then select feature fa

If SMDb<SMDa, then select feature fb

If SMDa=SMDb, then select any of features fa or fb Equation 7

Thus, as the cluster sizes of the two features in equation 7 are the same, the feature with most even distribution of assets (i.e., the feature with lowest SMD) is selected. Thus, at 372, one of the features fa or fb is selected according to equation 7, and the method 320 proceeds to 374, where the method 320 ends. The selection at 372 is used for subsequent steps of the method 300 of FIG. 3A.

On the other hand, if “No” at 372 (e.g., if the two identified features had different number of clusters), then the method 320 proceeds to 378. At 378, the feature selection module 112 calculates absolute difference between the mean of the two identified features, and calculates absolute difference between the SMDs of the two identified features, e.g., to generate an adjustment of deviation. FIG. 4F illustrates a table depicting absolute difference between mean of two identified features, and absolute difference between SMDs of two identified features, which are used to generate an adjustment of deviation, in accordance with some embodiments of the present disclosure. For example, as discussed with respect to FIG. 4E, features f2 and f1 having the lowest SMDs are identified at 366 of the method 320, and these two features have different number of clusters (i.e., “No” at 370). Accordingly, absolute difference between the mean of these two features, and absolute difference between SMDs of these features are calculated in FIG. 4F. For example, the absolute difference between the mean of these two features are M21=|27−41|, i.e., 14. The absolute difference between the SMDs of these two features are SMD21=β−2|, i.e., 1.

In general terms, assume features fc and fd having mean Mc and Md, respectively, and SMDc and SMDd, respectively, are identified at 366, and also assume that the features fc and fd have different number of clusters. Then the absolute difference between the mean of these two features, and absolute difference between SMDs of these features are calculated as follows at 378:

Absolute difference between the mean of the two features=Mcd=|Mc−Md|

Absolute difference between the SMDs of the two features=SMDcd=|SMDc−SMDd| Equation 8

Then the method proceeds to 382, where an (Adjustment of deviation (AoD)” factor is calculated as follows:

If “absolute difference between the two mean”≥“absolute difference between the two SMDs”, then “Adjustment of deviation” factor=1,

Otherwise, “Adjustment of deviation” factor=0 Equation 9a

Continuing with the above example of equation 8, equation 9a can be rewritten as:

AoD=1, if Mcd≥SMDcd,

AoD=0 otherwise Equation 9b

In the example of FIG. 4F, M21 (i.e., absolute difference between the mean of the features f2 and f1) is 14, while SMD21 (i.e., absolute difference between the SMD of the features f2 and f1) is 1. Thus, the Adjustment of deviation (AoD) factor is 1.

Once the AoD factor is calculated, the method 320 proceeds from 382 to 386, where a feature, from the identified two features, is selected as follows:

If Adjustment of deviation factor=1, select, from the two identified features, the feature with higher number of clusters; or

If Adjustment of deviation factor=0, select, from the two identified features, the feature with lower number of clusters Equation 10

In the example of FIG. 4E, the AoD factor is 1, and functions f2 and f1 have clusters 3 and 2, respectively. Accordingly, feature f2 is selected in 386 of the method 320, as illustrated in FIG. 4F. In an example, equations 8, 9a, 9b, and 10 aim to select, from the two identified features, a feature that is to relatively significantly reduce a number of search results, as will be discussed herein later.

After the selection at 386, the method 320 ends at 374. The selection at 386 is used for subsequent steps of the method 300 of FIG. 3A.

Referring again to method 300 of FIG. 3A, once a feature is selected at 320, the method 300 proceeds to 324, which includes sub-steps 324a, 324b, 324c.

For example, at 324a, the query module 104 and/or 204 cause presentation of a query to the user 101, based on the selected feature and the corresponding clusters. Similar to 308a, the query can be displayed on a display of the device 100, or may be audibly presented to the user 101. Merely as an example, in the example of FIG. 4F, the feature f2 was selected. The query is, thus, based on the feature f2 and it's associated clusters. For example, the user may be requested to choose among the clusters of feature f2. Merely as an example, feature f2 is “Length of video,” and the associated clusters are (C21) less than 5 minutes, (C22) 5-60 minutes, (C23) more than 1 hour. Thus, the query can be, as an example: “Do you remember the approximate length of the video? Is it less than 5 minutes, between 5 minutes to 60 minutes, or more than an hour?” This example query is also illustrated in the example interaction 400 of FIG. 4A.

At 324b, the query module 104 and/or 204 receive a response to the query from the user 101. In an example, the response includes a selection of a cluster of the various clusters of the selected and queried feature. Merely as an example, as illustrated in the interaction 400 of Fig. A, the user responds as follows: “I think greater than an hour.” Thus, the user selects the cluster C23 (more than 1 hour).

At 324c, the result generation module 106 refines the search results, based on the response to the query. For example, the result generation module 106 identifies and includes in the refined results the digital assets belonging to the cluster selected by the user 101, and discards digital assets belonging to the other clusters of the selected feature. In the context of the example of FIGS. 4A and 4F, digital assets that belong to cluster C23 (i.e., videos that are more than 1 hour long) are included in the refined search results. Remaining digital assets, such as assets belonging to clusters C21 (videos that are less than 5 minutes) and C22 (videos that are 5 to 60 minutes) of the feature f2 are not included in the refined search results. Merely as an example and as illustrated in FIG. 4A, the result generation module 106 refines and reduces the search results to 29 assets.

The method 300 then proceeds from 324 to 328, where the search system 102 determines whether a number of the refined search results is sufficiently small. For example, the search system 102 compares the number of refined search results of 324c to a threshold. In some embodiments, the threshold is user configurable, based on system settings, and/or based on capabilities of the user. Merely as an example, for a technologically not advanced user and/or a user with at least partial visual imparity, the threshold can be relatively low. For example, such a user may find it difficult to parse through the large number of search results, and may instead prefer an even smaller number of search results. On the other hand, for a technologically advanced user without such visual imparity, the threshold can be relatively high.

If “Yes” at 328 (i.e., the number of refined search results is sufficiently small), the method 300 proceeds to 332, where the search results are displayed.

On the other hand, if “No” at 328 (i.e., the number of refined search results is not sufficiently small), the method 300 loops back to 316, where the steps 316, 320, 324, and 328 are again repeated. It may be noted the before looping back, the method 300 comprises, at 336, discarding or omitting the feature(s) that have been previously been selected for purposes of performing steps 316 and 320 of the next iteration. For example, as the feature f2 was already selected during the first iteration of the method 300 and the user was already asked a question about it, there is no need to include the feature f2 in the selection process during the second iteration, and hence, feature f2 is discarded or omitted. This process is iteratively repeated, until the search results are sufficiently small.

The following discussion depicts an example of a second iteration of the steps 316, 320, 324, and 328 of the method 300. Assume that, as discussed herein above, the number of refined search results after the first iteration of these steps is 29 assets.

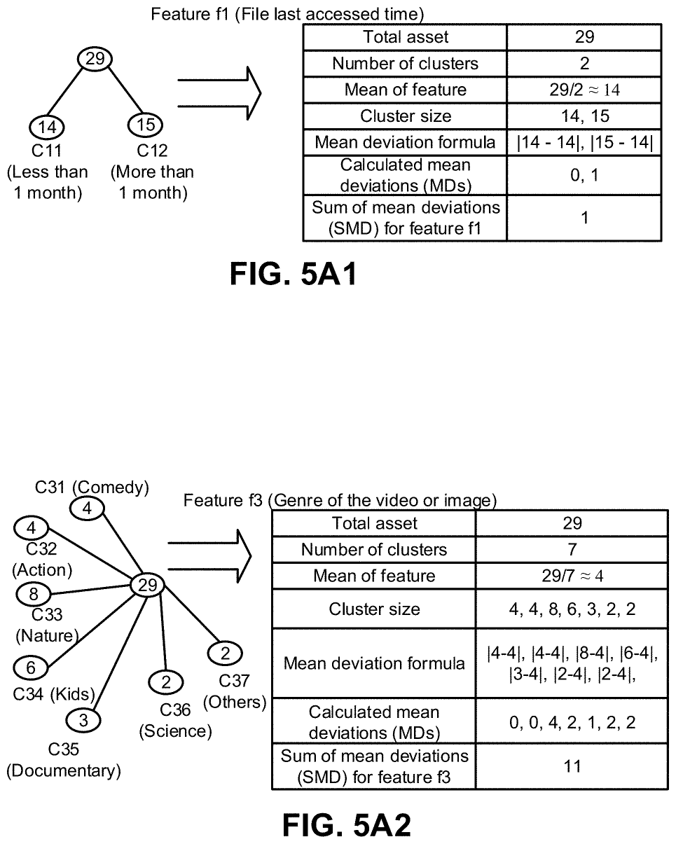

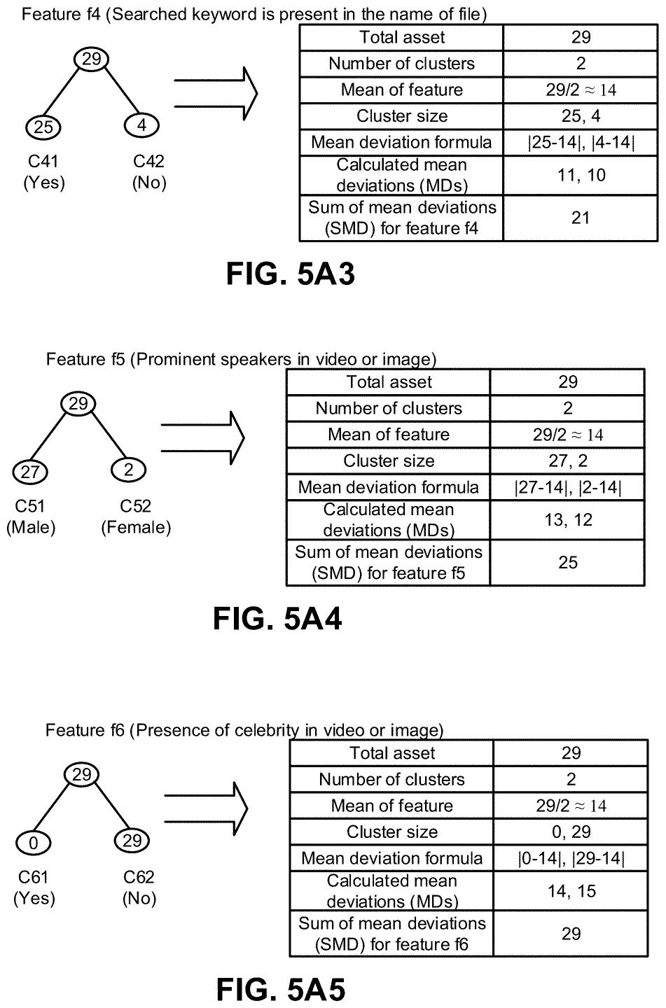

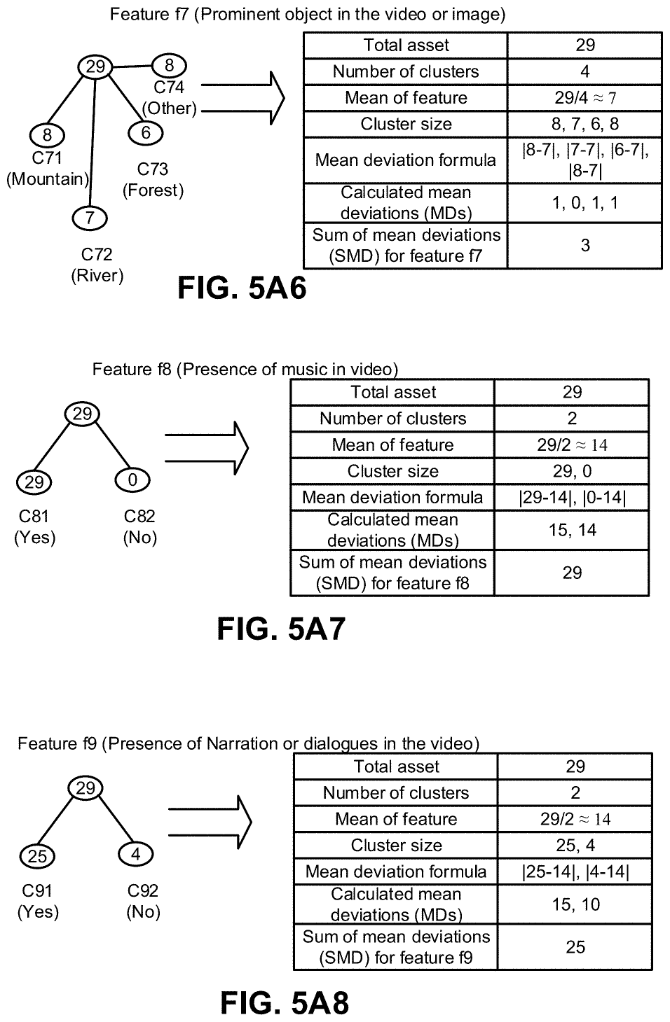

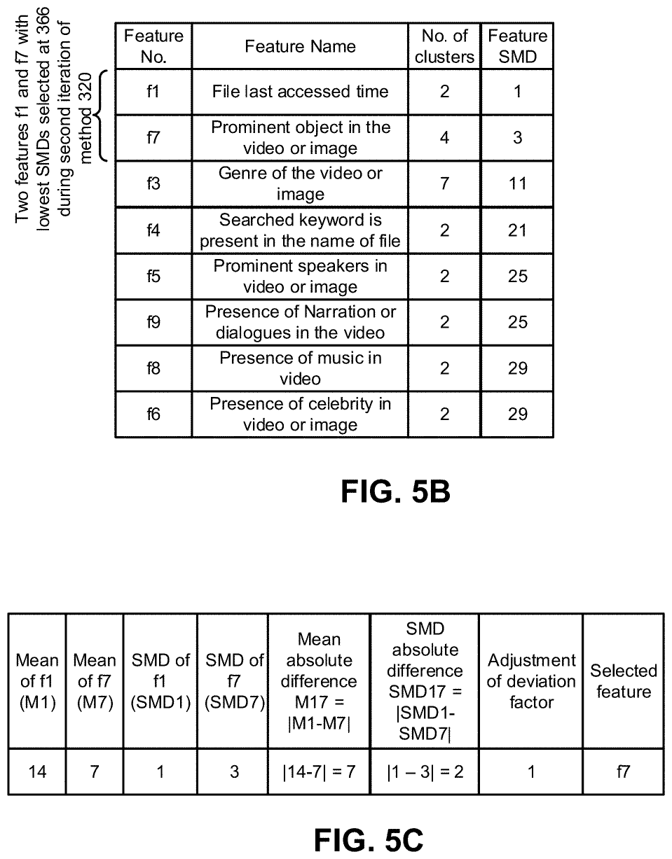

FIGS. 5A1, 5A2, 5A3, 5A4, 5A5, 5A6, 5A7, and 5A8 respectively illustrate example Mean Deviations (MD) and SMD calculations for various clusters for features f1, f3, f4, f5, f6, f7, f8, and f9, respectively, during a second iteration of the method 300 of FIG. 3A, in accordance with some embodiments of the present disclosure. Note that as feature f2 was selected during the first iteration of the method 300, MD and SMD for this feature is not needed, as discussed with respect to 336 of the method 300. Also note that the total number of assets categorized in the various clusters in FIGS. 5A1-5A8 is 29, as discussed above. The examples in FIGS. 5A1-5A8 are self explanatory, in view of the discussion with respect to FIGS. 4G1-4G9. For example, FIGS. 5A1-5A8 illustrate calculations for mean, mean deviations, and SMDs for features f1, f3, f4, f5, f6, P, f8, and f9, respectively.

FIG. 5B illustrates the example features f1, f3, . . . , f9 being ordered in an ascending order based on the corresponding SMDs during a second iteration of the method 300 of FIG. 3A, in accordance with some embodiments of the present disclosure. The values of FIG. 5B are from FIGS. 5A1-5A8. As seen, features f1 and P have the lowest SMDs, and hence, are selected at 366 during the second iteration of the method 300.

The number of clusters in features f1 and P are not same, and hence, the method 320 goes to 378, where the absolute differences in mean and SMDs are calculated. FIG. 5C illustrates absolute difference between mean of the features f1 and P, and absolute difference between SMDs of the features f1 and P, which are used to generate an adjustment of deviation factor during the second iteration of the method 300 of FIG. 3A, in accordance with some embodiments of the present disclosure. FIG. 5C is self-explanatory, in view of the discussion with respect to FIG. 4F. For example, in accordance with equation 9a, the AoD factor is calculated as 1. Hence, in accordance with equation 10, the feature P is selected at 386 of method 320, as illustrated in FIG. 5C.

Accordingly, at 324, the user 101 is queried based on the selected feature P. For example, as illustrated in the interaction 400 of FIG. 4A, the user 101 may be presented with the following query: “Which prominent object is present in the video of your interest: mountain, river, forest, or something else?” Thus, the query requests the user 101 to select a cluster among the plurality of clusters of the selected feature P.

In the example interaction 400 of FIG. 4A, the user selects the cluster C71 (Mountain). Accordingly, the result generation module 106 further refines the search results to keep digital assets with mountains as prominent object, and discard digital assets that have river, forest, or something else as prominent objects. In the example interaction 400 of FIG. 4A, this reduces the search results to 6. In an example, the number of search results (i.e., 6) is now less than the threshold discussed with respect to 328 of method 300 (i.e., the number of search results is now sufficiently small). Hence, as symbolically illustrated in the example interaction 400 of FIG. 4A, the search system 102 displays the 6 search results to the user 101. The user 101 may linearly go through the 6 search results, to find the digital asset of his or her interest.

Thus, in an example and as illustrated in FIG. 4A, the initial 234 search results were reduced to 83 search results, which were further reduced to 29 search results, which were in turn reduced to merely 6 search results. The reduction in the search results occurs in the course of three interactions between the user 101 and the search system 102.

In some embodiments, such drastic reduction of search results is possible due to the intelligence in selection of a feature at each turn in the interaction between the user 101 and the search system 102, and requesting the user 101 to select a cluster of the selected feature. If the feature selection is not done intelligently and is done randomly, such a high reduction in the search results may not be achievable.

For example, referring to FIGS. 4A1-4D9, assume that contrary to the selection process of method 300, during the first iteration of the method 300, the search system 102 randomly selects feature f8 and queries the user 101 about feature f8. In such an example, the user 101 will most likely select cluster C81, as cluster C81 has 81 assets and cluster C82 has merely 2 assets (see FIG. 4D8). This will reduce the search results from 83 to 81. In contrast, if the selection is done in accordance with the method 300, the search results are reduced from 83 to 29, as discussed herein.

In another example, referring to FIGS. 4A1-4D9, assume that contrary to the selection process of method 300, during the first iteration of the method 300, the search system 102 randomly selects feature f1 and queries the user 101 about feature f1. In such an example, the user 101 will likely select any of the clusters C11 or C12 (see FIG. 4D1). This will reduce the search results from 83 to either 40 or 43. In contrast, if the selection is done in accordance with the method 300, the search results are likely to be reduced from 83 to 29, as discussed herein.

Thus, in the feature selection process discussed herein with respect to the methods 300 and 320 of FIGS. 3A and 3B, the reduction in the search results is much higher than it would have been for a random feature selection process. Put differently, the feature selection process discussed herein has a relatively high probability of greater reduction in the search results, compared to what is likely to be achievable via random selection of the feature.

Thus, the interaction 400 between the user 101 and the search system 102 is based on dynamic and intelligent selection of features, rather than any random selection of features—such dynamic and intelligent selection of features ensures higher probability of relatively higher reduction in the search results with a relatively fewer number of interactions between the user 101 and the search system 102. This helps in a technologically non-advanced user and/or a visually challenged user to relatively quickly locate the asset of his or her interest. This results in a better, quicker, and more streamlined search experience for the user 101.

As discussed, in some embodiments, the search process discussed herein is associated to a scenario where the user 101 is searching for files stored in his or her local device (such as database 146a within the device 100). In some other embodiments, the search process discussed herein is associated to a scenario where the user 101 is searching for files stored in a remote location, such as a cloud-based storage system (such as database 146b remote to the device 100). In such embodiments where the user 101 is searching for one or more digital assets within her local device and/or within the cloud, the user 101 may have accessed the digital asset(s) before. Accordingly, features like “File last accessed time,” “Searched keyword is present in the name of file,” are relevant for the search process.

However, if the user is searching, for example, digital assets within the Internet, the feature set can be updated accordingly. For example, in such scenarios, features like “File last accessed time,” “Searched keyword is present in the name of file,” may not be relevant, as the user 101 may not have accessed the files before (or the search engine may not have stored records of the user 101 accessing the files before). Accordingly, the features can be modified to be appropriate for such situations.

Numerous variations and configurations will be apparent in light of this disclosure and the following examples.

Example 1. A method for providing an interactive search session, the method comprising: receiving a search query; generating a first plurality of search results, in response to the search query; identifying, for each feature of a plurality of features, a corresponding plurality of clusters, wherein a cluster of a feature represents a corresponding range or value of the feature; for each feature, categorizing the first plurality of search results into the corresponding plurality of clusters of the corresponding feature; selecting a feature from the plurality of features, based on categorizing the first plurality of search results; causing presentation of a message requesting a user to identify a cluster of the plurality of clusters of the selected feature in which one or more intended search results belong; and generating a second plurality of search results by discarding one or more search results from the first plurality of search results, based on a response to the message.

Example 2. The method of example 1, wherein categorizing the first plurality of results comprises: categorizing the first plurality of results, such that each of the first plurality of search results is (i) categorized into a corresponding one of a first plurality of clusters of a first feature, (ii) categorized into a corresponding one of a second plurality of clusters of a second feature, and (ii) categorized into a corresponding one of a third plurality of clusters of a third feature.

Example 3. The method of example 2, wherein selecting the feature from the plurality of features comprises: determining that the first plurality of search results is more evenly distributed among various clusters of the first feature and the second feature, compared to that for the third feature; and selecting one of the first feature or the second feature.

Example 4. The method of any of examples 2-3, wherein the first plurality of search results has N number of search results, wherein the first feature has X1 number of clusters, wherein the second feature has X2 number of clusters, wherein the third feature has X3 number of clusters, wherein each of N, X1, X2, and X3 is a positive integer greater than 1, wherein selecting the feature from the plurality of features comprises: calculating (i) for the first feature, a first mean that is based on a ratio of N and X1, (ii) for the second feature, a second mean that is based on a ratio of N and X2, and (iii) for the third feature, a third mean that is based on a ratio of N and X3; calculating (i) a first Summation of Mean Deviation (SMD) for the first feature, based on the first mean, (ii) a second SMD for the second feature, based on the second mean, and (iii) a third SMD for the third feature, based on the third mean; and selecting the feature from the plurality of features, based on the first SMD, the second SMD, and the third SMD.

Example 5. The method of example 4, wherein calculating the first SMD comprises: calculating, for each cluster of the first plurality of clusters of the first feature, a corresponding Mean Deviation (MD), such that a first plurality of MDs is calculated corresponding to the first plurality of clusters of the first feature, wherein a MD of a cluster of the first plurality of clusters is an absolute difference between (i) a number of search results categorized in the cluster, and (ii) the first mean of the first feature; and calculating the first SMD to be based on a summation of the first plurality of MDs,

Example 6. The method of any of examples 4-5, wherein selecting the feature from the plurality of features comprises: determining that each of the first SMD and the second SMD is less than the third SMD; and selecting one of the first feature or the second feature, but not the third feature, based on determining that each of the first SMD and the second SMD is less than the third SMD.

Example 7. The method of example 6, wherein selecting the feature from the plurality of features comprises: determining that X1 and X2 are equal; and selecting one of the first feature or the second feature that has the lowest SMD, based on determining that X1 and X2 are equal.

Example 8. The method of example 6, wherein selecting the feature from the plurality of features comprises: determining that X1 is not equal to X2; in response to determining that X1 is not equal to X2, calculating an Adjustment of Deviation (AoD) factor, based on the first mean, the second mean, the first SMD, and the second SMD; and selecting one of the first feature or the second feature, based on the AoD factor.

Example 9. The method of example 8, wherein calculating the AoD factor comprises: calculating a first absolute difference the first mean and the second mean; calculating a second absolute difference the first SMD and the second SMD; and performing one of (i) in response to the first absolute difference being equal to or greater than the second absolute difference, setting the AoD factor to 1, or (ii) in response to the first absolute difference being less than the second absolute difference, setting the AoD factor to 0.

Example 10. The method of any of examples 8-9, wherein selecting one of the first feature or the second feature comprises: performing one of (i) in response to the AoD factor being 1, selecting one of the first feature or the second feature that has a higher number of clusters, or (ii) in response to the AoD factor being 0, selecting one of the first feature or the second feature that has a lower number of clusters.

Example 11. The method of any of examples 1-10, further comprising: in response to the second plurality of search results being higher than a threshold, selecting another feature from the plurality of features; causing presentation of another message requesting the user to identify a cluster of the plurality of clusters of the selected another feature in which the one or more intended search results belong; and generating a third plurality of search results by discarding another one or more search results from the second plurality of search results, based on a response to the other message.

Example 12. The method of any of examples 1-11, wherein: a first feature of the plurality of features comprises a duration of video; and wherein a first plurality of clusters corresponding to the first feature comprises at least one of (i) a first cluster comprising videos that are within a first duration range, and (ii) a second cluster comprising videos that are within a second duration range.

Example 13. The method of any of examples 1-12, wherein: a first feature of the plurality of features comprises a last accessed time of a file; and wherein a first plurality of clusters corresponding to the first feature comprises at least one of (i) a first cluster comprising files accessed within a first time-range, and (ii) a second cluster comprising files accessed within a second time-range.

Example 14. The method of any of examples 1-13, wherein prior to identifying a corresponding plurality of clusters, the method further comprises: prompting the user to identify whether the one or more intended search results are textual files or non-textual files; and refining the first plurality of search results, based a response to the prompt.

Example 15. A system for generating search results, the system comprising: one or more processors; and a search system executable by the one or more processors to receive a search query, generate a first plurality of search results, in response to the search query, identify, for each feature of a plurality of features, a corresponding plurality of clusters, wherein a cluster of a feature represents a corresponding range or value of the feature, for each feature, categorize the first plurality of search results into the corresponding plurality of clusters of the corresponding feature, calculate a plurality of Summation of Mean Deviations (SMDs) corresponding to the plurality of features, wherein an SMD of a feature is indicative of how evenly the first plurality of search results are distributed within the corresponding plurality of clusters of the corresponding feature, select a feature from the plurality of features, based on the plurality of SMDs, cause presentation of a message associated with the selected feature to a user, and generate a second plurality of search results by refining the first plurality of search results, based on a response to the message.

Example 16. The system of example 15, wherein: a relatively lower value of an SMD of a feature is an indication that the first plurality of search results is relatively more uniformly distributed within the corresponding plurality of clusters; and the selected feature has an SMD value that is less than SMDs of at least one or more other features.

Example 17. The system of any of examples 15-16, wherein: the message is to request the user to select a cluster of the plurality of clusters of the selected feature.

Example 18. A computer program product including one or more non-transitory machine-readable mediums encoded with instructions that when executed by one or more processors cause a process to be carried out for generating search results, the process comprising: generating an initial set of search results, in response to an initial search query from a user, the initial query to identify a digital asset of interest; prompting the user to identify whether the digital asset of interest is a textual file or a non-textual file; refining the initial set of search results, based a response to the prompting, thereby generating a refined set of search results; for each feature of a plurality of features, categorizing the refined set of search results into the corresponding plurality of clusters of the corresponding feature, wherein a cluster of a feature represents a corresponding range or value of the feature; selecting a feature from the plurality of features; receiving an identification of a cluster of the selected feature, the identified cluster including one or more intended search results; and refining the refined set of search results to generate a further refined set of search results, based on the identification of the cluster of the selected feature.

Example 19. The computer program product of example 18, wherein categorizing the refined set of search results comprises: categorizing the refined set of search results such that, for a given feature, a search result is categorized into exactly one cluster of a plurality of clusters of the given feature.

Example 20. The computer program product of example 19, wherein categorizing the refined set of search results comprises: categorizing the refined set of search results such that the search result is categorized in (i) a corresponding cluster of a first feature, (ii) another corresponding cluster of a second feature, and (iii) yet another corresponding cluster of a third feature.

The foregoing detailed description has been presented for illustration. It is not intended to be exhaustive or to limit the disclosure to the precise form described. Many modifications and variations are possible in light of this disclosure. Therefore, it is intended that the scope of this application be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method for providing an interactive search session, the method comprising:
receiving a search query;
generating a first plurality of search results, in response to the search query;
identifying, for each feature of a plurality of features, a corresponding plurality of clusters, wherein a cluster of a feature represents a corresponding range or value of the feature;
for each feature, categorizing the first plurality of search results into the corresponding plurality of clusters of the corresponding feature;
selecting a feature from the plurality of features, based on categorizing the first plurality of search results;
causing presentation of a message requesting a user to identify a cluster of the plurality of clusters of the selected feature in which one or more intended search results belong; and
generating a second plurality of search results by discarding one or more search results from the first plurality of search results, based on a response to the message.

2. The method of claim 1, wherein categorizing the first plurality of results comprises:
categorizing the first plurality of results, such that each of the first plurality of search results is (i) categorized into a corresponding one of a first plurality of clusters of a first feature, (ii) categorized into a corresponding one of a second plurality of clusters of a second feature, and (ii) categorized into a corresponding one of a third plurality of clusters of a third feature.

3. The method of claim 2, wherein selecting the feature from the plurality of features comprises:
determining that the first plurality of search results is more evenly distributed among various clusters of the first feature and the second feature, compared to that for the third feature; and
selecting one of the first feature or the second feature.

4. The method of claim 2, wherein the first plurality of search results has N number of search results, wherein the first feature has X1 number of clusters, wherein the second feature has X2 number of clusters, wherein the third feature has X3 number of clusters, wherein each of N, X1, X2, and X3 is a positive integer greater than 1, wherein selecting the feature from the plurality of features comprises:
calculating (i) for the first feature, a first mean that is based on a ratio of N and X1, (ii) for the second feature, a second mean that is based on a ratio of N and X2, and (iii) for the third feature, a third mean that is based on a ratio of N and X3;
calculating (i) a first Summation of Mean Deviation (SMD) for the first feature, based on the first mean, (ii) a second SMD for the second feature, based on the second mean, and (iii) a third SMD for the third feature, based on the third mean; and
selecting the feature from the plurality of features, based on the first SMD, the second SMD, and the third SMD.

5. The method of claim 4, wherein calculating the first SMD comprises:
calculating, for each cluster of the first plurality of clusters of the first feature, a corresponding Mean Deviation (MD), such that a first plurality of MDs is calculated corresponding to the first plurality of clusters of the first feature, wherein a MD of a cluster of the first plurality of clusters is an absolute difference between (i) a number of search results categorized in the cluster, and (ii) the first mean of the first feature; and
calculating the first SMD to be based on a summation of the first plurality of MDs,

6. The method of claim 4, wherein selecting the feature from the plurality of features comprises:
determining that each of the first SMD and the second SMD is less than the third SMD; and
selecting one of the first feature or the second feature, but not the third feature, based on determining that each of the first SMD and the second SMD is less than the third SMD.

7. The method of claim 6, wherein selecting the feature from the plurality of features comprises:
determining that X1 and X2 are equal; and
selecting one of the first feature or the second feature that has the lowest SMD, based on determining that X1 and X2 are equal.

8. The method of claim 6, wherein selecting the feature from the plurality of features comprises:
determining that X1 is not equal to X2;
in response to determining that X1 is not equal to X2, calculating an Adjustment of Deviation (AoD) factor, based on the first mean, the second mean, the first SMD, and the second SMD; and
selecting one of the first feature or the second feature, based on the AoD factor.

9. The method of claim 8, wherein calculating the AoD factor comprises:
calculating a first absolute difference the first mean and the second mean;
calculating a second absolute difference the first SMD and the second SMD; and
performing one of (i) in response to the first absolute difference being equal to or greater than the second absolute difference, setting the AoD factor to 1, or (ii) in response to the first absolute difference being less than the second absolute difference, setting the AoD factor to 0.

10. The method of claim 8, wherein selecting one of the first feature or the second feature comprises:
performing one of (i) in response to the AoD factor being 1, selecting one of the first feature or the second feature that has a higher number of clusters, or (ii) in response to the AoD factor being 0, selecting one of the first feature or the second feature that has a lower number of clusters.

11. The method of claim 1, further comprising:
in response to the second plurality of search results being higher than a threshold, selecting another feature from the plurality of features;
causing presentation of another message requesting the user to identify a cluster of the plurality of clusters of the selected another feature in which the one or more intended search results belong; and
generating a third plurality of search results by discarding another one or more search results from the second plurality of search results, based on a response to the other message.

12. The method of claim 1, wherein:
a first feature of the plurality of features comprises a duration of video; and
wherein a first plurality of clusters corresponding to the first feature comprises at least one of (i) a first cluster comprising videos that are within a first duration range, and (ii) a second cluster comprising videos that are within a second duration range.

13. The method of claim 1, wherein:
a first feature of the plurality of features comprises a last accessed time of a file; and
wherein a first plurality of clusters corresponding to the first feature comprises at least one of (i) a first cluster comprising files accessed within a first time-range, and (ii) a second cluster comprising files accessed within a second time-range.

14. The method of claim 1, wherein prior to identifying a corresponding plurality of clusters, the method further comprises:
prompting the user to identify whether the one or more intended search results are textual files or non-textual files; and
refining the first plurality of search results, based a response to the prompt.

15. A system for generating search results, the system comprising:
one or more processors; and
a search system executable by the one or more processors to
receive a search query,
generate a first plurality of search results, in response to the search query,
identify, for each feature of a plurality of features, a corresponding plurality of clusters, wherein a cluster of a feature represents a corresponding range or value of the feature,
for each feature, categorize the first plurality of search results into the corresponding plurality of clusters of the corresponding feature,
calculate a plurality of Summation of Mean Deviations (SMDs) corresponding to the plurality of features, wherein an SMD of a feature is indicative of how evenly the first plurality of search results are distributed within the corresponding plurality of clusters of the corresponding feature,
select a feature from the plurality of features, based on the plurality of SMDs,
cause presentation of a message associated with the selected feature to a user, and
generate a second plurality of search results by refining the first plurality of search results, based on a response to the message.

16. The system of claim 15, wherein:
a relatively lower value of an SMD of a feature is an indication that the first plurality of search results is relatively more uniformly distributed within the corresponding plurality of clusters; and
the selected feature has an SMD value that is less than SMDs of at least one or more other features.

17. The system of claim 15, wherein:
the message is to request the user to select a cluster of the plurality of clusters of the selected feature.

18. A computer program product including one or more non-transitory machine-readable mediums encoded with instructions that when executed by one or more processors cause a process to be carried out for generating search results, the process comprising:
generating an initial set of search results, in response to an initial search query from a user, the initial query to identify a digital asset of interest;
prompting the user to identify whether the digital asset of interest is a textual file or a non-textual file;
refining the initial set of search results, based a response to the prompting, thereby generating a refined set of search results;
for each feature of a plurality of features, categorizing the refined set of search results into the corresponding plurality of clusters of the corresponding feature, wherein a cluster of a feature represents a corresponding range or value of the feature;
selecting a feature from the plurality of features;
receiving an identification of a cluster of the selected feature, the identified cluster including one or more intended search results; and
refining the refined set of search results to generate a further refined set of search results, based on the identification of the cluster of the selected feature.

19. The computer program product of claim 18, wherein categorizing the refined set of search results comprises:
categorizing the refined set of search results such that, for a given feature, a search result is categorized into exactly one cluster of a plurality of clusters of the given feature.

20. The computer program product of claim 19, wherein categorizing the refined set of search results comprises:
categorizing the refined set of search results such that the search result is categorized in (i) a corresponding cluster of a first feature, (ii) another corresponding cluster of a second feature, and (iii) yet another corresponding cluster of a third feature.
